(19) United States
(12) Patent Application Publication
(10) Pub. No.: US 2014/0375907 A1
(43) Pub. Date: Dec. 25, 2014

(54) TOUCH DISPLAY PANEL AND TOUCH DISPLAY APPARATUS

(71) Applicant: GIO Optoelectronics Corp., Tainan City (TW)

(72) Inventor: YUAN-LIANG WU, Tainan City (TW)

(21) Appl. No.: 14/309,878

(22) Filed: Jun. 19, 2014

(30) Foreign Application Priority Data
Jun. 20, 2013 (TW) 102121981
Feb. 14, 2014 (TW) 103104976
May 19, 2014 (TW) 103117536

(51) Int. Cl. G06F 3/044

(52) U.S. Cl. CPC G06F 3/044
USPC 349/12

(57) ABSTRACT

A touch display panel includes a first substrate, a second substrate, a touch electrode unit and at least one conducting unit. The second substrate is disposed opposite to the first substrate. The second substrate has a conductive pattern layer. The touch electrode unit is disposed on one side of the first substrate which is away from the second substrate. One end of the conducting unit is connected to the touch electrode unit, and the other end of the conducting unit is connected to the conductive pattern layer of the second substrate.

### CROSS REFERENCE TO RELATED APPLICATIONS

This Non-provisional application claims priority under 35 U.S.C. §119(a) on Patent Application No(s). 102121981, 103104976 and 103117536 filed in Taiwan, Republic of China on Jun. 20, 2013, Feb. 14, 2014 and May 19, 2014, the entire contents of which are hereby incorporated by reference.

### BACKGROUND OF THE INVENTION

1. Field of Invention

The invention relates to a touch display panel and a touch display apparatus.

2. Related Art

As the progressive of technology, various kinds of information devices, such as cell phones, tablet computers, UMPC, GPS and the likes, have been invented. Except the conventional input approach by keyboard and/or mouse, the touch input technology is an intuitional and popular choice recently. For example, the touch display panel has humanity and intuitional input interface, so the users of any ages can directly operate it by fingers or stylus. Accordingly, the touch display panel products are more and more popular in the market.

In general, the touch display apparatus can be divided into an in cell touch display apparatus and an on cell touch display apparatus. In the in cell touch display apparatus, a sensing electrode layer is disposed in a display panel (e.g. LCD panel); otherwise, in the on cell touch display apparatus, a touch panel is disposed on a display panel. Regarding the frequently seen on-cell-touch touch display panel, the conductive traces of the display panel have to be electrically connected to the driving circuit through a flexible print circuit (FPC), and the touch panel also has to be electrically connected to another FPC and thus connected to the external control chip through the FPC so that the electrodes of the touch electrode unit can work. Consequently, each of the display panel and the touch panel requires one FPC, and the size of the touch display apparatus is enlarged. However, the current requirement of the user on the touch display apparatus tends to be thin and light.

Therefore, it is an important subject to provide a touch display panel and a touch display apparatus having a novel structure design to form the thinner and lighter structure.

### SUMMARY OF THE INVENTION

In view of the foregoing subject, an objective of the invention is to provide a touch display panel and a touch display apparatus having a novel structure design to form the thinner and lighter structure.

To achieve the above objective, the present invention discloses a touch display panel including a first substrate, a second substrate, a touch electrode unit and at least one conducting unit. The second substrate is disposed opposite to the first substrate and has a conductive pattern layer. The touch electrode unit is disposed on one side of the first substrate, which is away from the second substrate. At least one conducting unit has one end connected to the touch electrode unit, and the other end connected to the conductive pattern layer of the second substrate.

In one embodiment, the touch display panel further includes a support formed on an interface between a surface of the second substrate and a side surface of the first substrate, and the conducting unit is formed on the support.

In one embodiment, the conducting unit comprises a flexible printed circuit.

In one embodiment, the touch display panel includes a plurality of conducting units, and the touch electrode unit includes a plurality of first direction electrodes and a plurality of second direction electrodes. The first direction electrodes and the second direction electrodes are electrically connected to the conductive pattern layer on different lateral sides of the second substrate through the conducting units, respectively.

In one embodiment, the first substrate has a plurality of first through holes, a first surface and a second surface opposite to the first surface. The first through holes penetrate through the first surface and the second surface, and the touch electrode unit and the first surface of the first substrate are disposed on the same side.

In one embodiment, the touch display panel further includes a jointing element, which is disposed between the first substrate and the second substrate, and has at least one second through hole. At least a portion of the second through hole is disposed correspondingly to one of the first through holes.

In one embodiment, the conducting unit includes a first conducting material and a second conducting material. The first conducting material is disposed on an inside or a hole wall of the first through hole, and the second conducting material is disposed in the second through hole. The touch electrode unit is electrically connected to the conductive pattern layer of the second substrate through the first conducting material of the first through hole and the second conducting material of the second through hole.

In one embodiment, at least a portion of the first through holes is disposed in a contact region between the first substrate and the jointing element.

In one embodiment, the conducting unit includes a conducting jointing element, which is disposed between the first substrate and the second substrate, and electrically connected to the first through holes.

In one embodiment, at least a portion of the first through holes is disposed in a contact region between the first substrate and the conducting jointing element.

In one embodiment, the touch display panel further includes a touch control integrated circuit, which is disposed on the second substrate and electrically connected to the conducting unit through the conductive pattern layer of the second substrate.

In one embodiment, the touch display panel further includes a touch control integrated circuit and an electrical connection member. The conductive pattern layer of the second substrate is electrically connected to the touch control integrated circuit through the electrical connection member.

In one embodiment, the touch display panel includes a liquid crystal display panel, a light emitting diode (LED) display panel or an organic light emitting diode (OLED) display panel.

To achieve the above objective, the present invention also discloses a touch display panel including a first substrate, a second substrate and a touch electrode unit. The first substrate has a plurality of first through holes, a conductive pattern layer, a first surface and a second surface opposite to the first surface. The first through holes penetrate through the first surface and the second surface, and the conductive pattern layer is disposed on the second surface of the first substrate. The second substrate is disposed opposite to the first substrate. The touch electrode unit is disposed on the same side as the first surface of the first substrate. The touch electrode unit is electrically connected to one side of the second surface of the first substrate through the first through holes, and the conductive pattern layer is electrically connected to the touch electrode unit through the first through holes.

To achieve the above objective, the present invention also discloses a touch display apparatus including a backlight source module and a touch display panel. The touch display panel includes a first substrate, a second substrate, a touch electrode unit and at least one conducting unit. The second substrate is disposed opposite to the first substrate and has a conductive pattern layer. The touch electrode unit is disposed on one side of the first substrate which is away from the second substrate. The conducting unit has one end connected to the touch electrode unit, and the other end connected to the conductive pattern layer of the second substrate. The backlight source module is disposed on one side of the second substrate.

In one embodiment, the touch display apparatus further includes a support formed on an interface between a surface of the second substrate and a side surface of the first substrate, and the conducting unit is formed on the support.

In one embodiment, the conducting unit includes a flexible printed circuit.

In one embodiment, the touch display panel includes a plurality of conducting units, and the touch electrode unit includes a plurality of first direction electrodes and a plurality of second direction electrodes. The first direction electrodes and the second direction electrodes are electrically connected to the conductive pattern layer on different lateral sides of the second substrate through the conducting units, respectively.

In one embodiment, the touch display apparatus further includes a touch control integrated circuit disposed on the second substrate and electrically connected to the conducting unit through the conductive pattern layer of the second substrate.

In one embodiment, the touch display apparatus further includes a touch control integrated circuit and an electrical connection member. The conductive pattern layer of the second substrate is electrically connected to the touch control integrated circuit through the electrical connection member.

In one embodiment, the touch display apparatus includes a liquid crystal display panel.

As mentioned above, the touch display panel and the touch display apparatus of the invention electrically connect the touch electrode units to the conductive pattern layer through the conducting units, so that the touch panel and the display panel share the integrated circuit. In some embodiments, the touch electrode unit may be electrically connected to the conductive pattern layer to share the integrated circuit through the conducting unit, so that the use of the integrated circuit can be decreased.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a pictorial view showing a touch display panel according to a first embodiment of the invention.

FIG. 1B is a cross-sectional view taken along a line A-A of the touch display panel of FIG. 1A.

FIG. 1C is a schematic top view showing the touch electrode unit of FIG. 1A.

FIG. 1D is a pictorial view showing another aspect of the touch electrode unit of FIG. 1A.

FIG. 1E is a cross-sectional view showing another aspect of a touch display panel according to the first embodiment of the invention.

FIG. 1F is a cross-sectional view showing still another aspect of a touch display panel according to the first embodiment of the invention.

FIG. 2A is a pictorial view showing an aspect of a touch display panel according to a second embodiment of the invention.

FIG. 2B is a cross-sectional view taken along a line B-B of the touch display panel of FIG. 2A.

FIG. 2C is a pictorial view showing another aspect of a touch display panel according to the second embodiment of the invention.

FIG. 2D is a cross-sectional view taken along a line C-C of the touch display panel of FIG. 2C.

FIG. 2E is a pictorial view showing still another aspect of a touch display panel according to the second embodiment of the invention.

FIG. 2F is a cross-sectional view taken along a line D-D of the touch display panel of FIG. 2E.

FIG. 3A is a pictorial view showing an aspect of a touch display panel according to a third embodiment of the invention.

FIG. 3B is a cross-sectional view taken along a line E-E of the touch display panel of FIG. 3A.

FIG. 3C is a pictorial view showing another aspect of a touch display panel according to the third embodiment of the invention.

FIG. 3D is a pictorial view showing still another aspect of a touch display panel according to the third embodiment of the invention.

FIG. 3E is a cross-sectional view taken along a line F-F of the touch display panel of FIG. 3D.

FIG. 3F is a schematic view showing yet still another aspect of a touch display panel according to the third embodiment of the invention.

FIG. 3G is a schematic view showing yet still another aspect of a touch display panel according to the third embodiment of the invention.

FIG. 4A is a cross-sectional view showing a touch display panel according to a fourth embodiment of the invention.

FIG. 4B is a schematic top view showing the touch electrode unit of FIG. 4A.

FIG. 4C is a schematic view showing another implementation of a touch display panel according to the fourth embodiment of the invention.

FIG. 4D is a schematic view showing still another implementation of a touch display panel according to the fourth embodiment of the invention.

FIG. 4E is a schematic top view showing the touch display panel of FIG. 4A.

FIG. 4F is a schematic view showing another implementation of a touch control integrated circuit of the touch display panel of FIG. 4E.

FIG. 5 is a cross-sectional view showing a touch display panel according to a fifth embodiment of the invention.

FIG. 6 is a cross-sectional view showing a touch display panel according to a sixth embodiment of the invention.

FIG. 7 is a cross-sectional view showing a touch display panel according to a seventh embodiment of the invention.

FIG. 8 is a cross-sectional view showing a touch display apparatus according to one embodiment of the invention.

FIG. 9 is a cross-sectional view showing a touch display apparatus according to another embodiment of the invention.

### DETAILED DESCRIPTION OF THE INVENTION

The present invention will be apparent from the following detailed description, which proceeds with reference to the accompanying drawings, wherein the same references relate to the same elements. Drawings for all embodiments of the invention are only for the illustrative purpose only and do not intend to represent the true size and proportion.

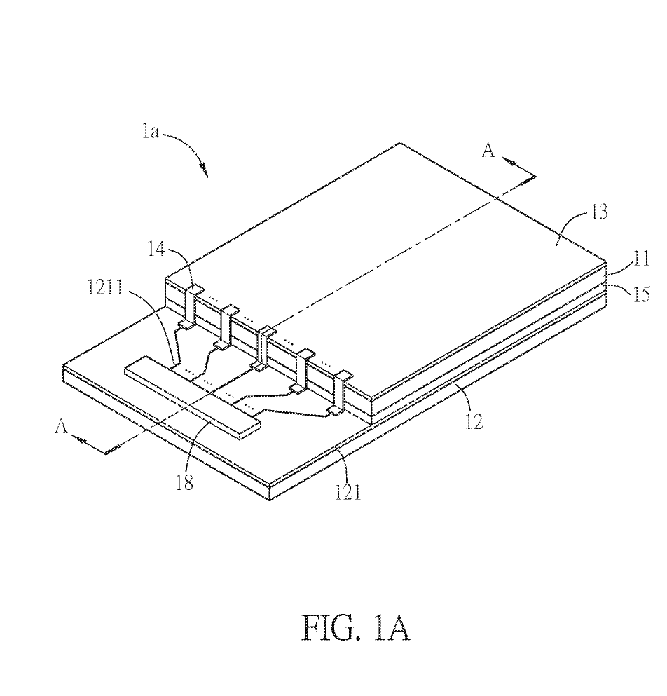

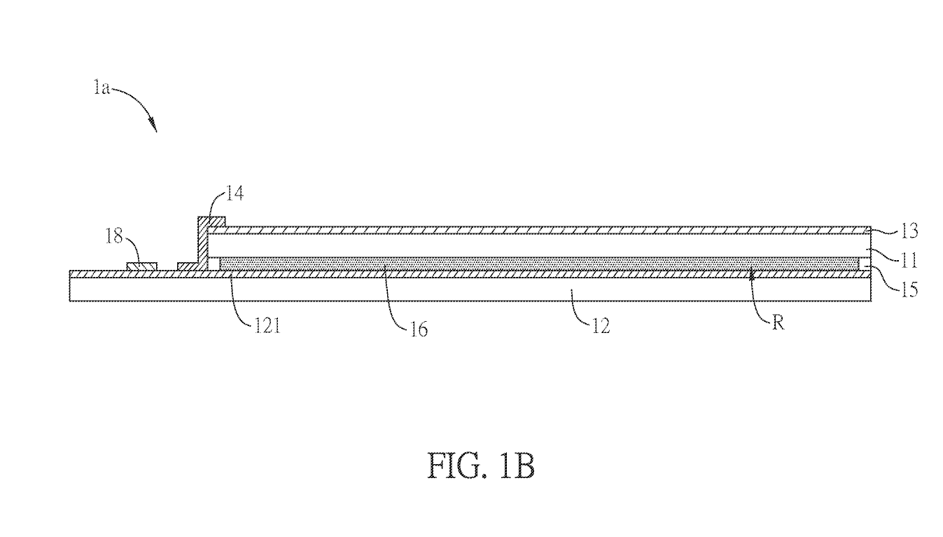

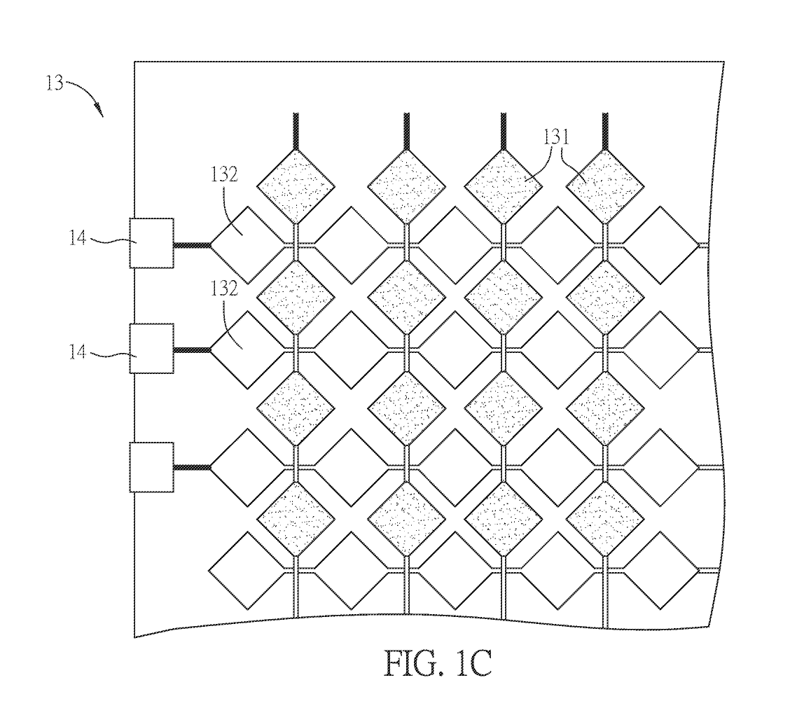

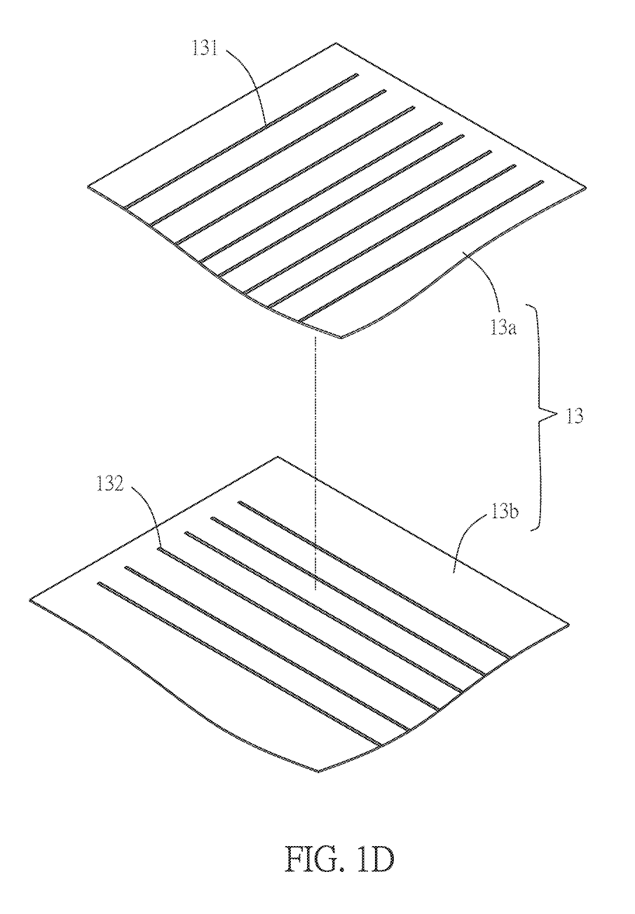

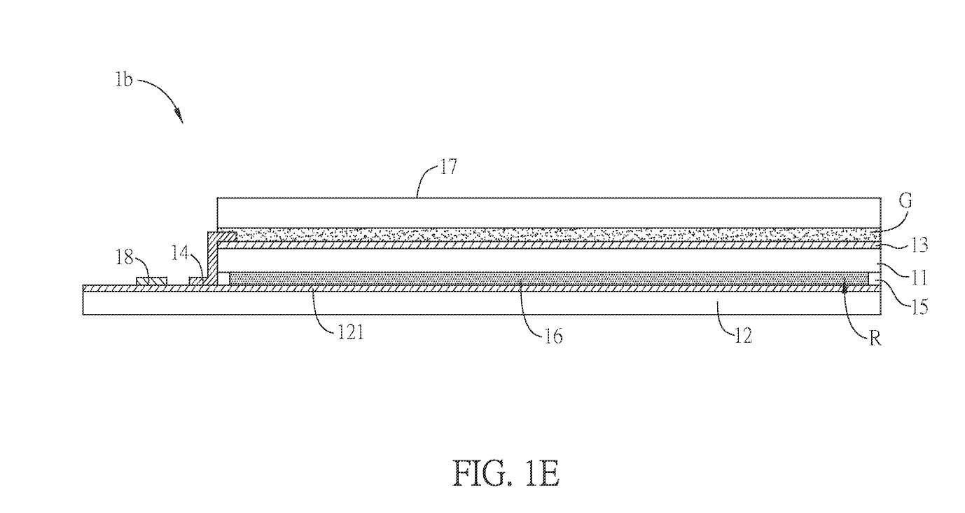

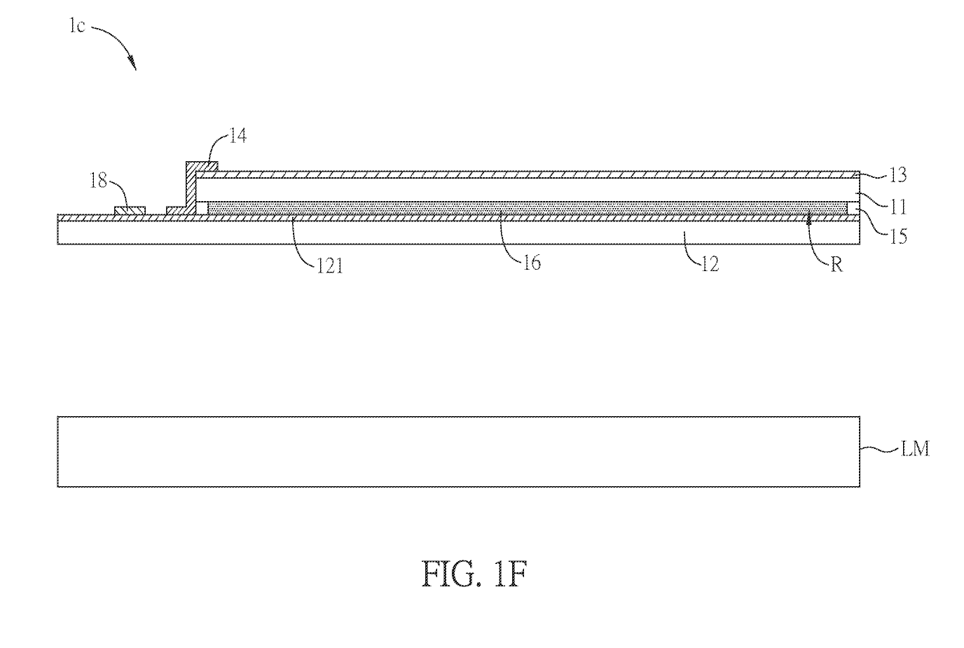

FIG. 1A is a pictorial view showing a touch display panel according to a first embodiment of the invention. FIG. 1B is a cross-sectional view taken along a line A-A of the touch display panel of FIG. 1A. Referring to FIGS. 1A and 1B, a touch display panel 1a includes a first substrate 11, a second substrate 12, a touch electrode unit 13 and at least one conducting unit 14.

The first substrate 11 may be a color filter (CF) substrate of a display module or a cover substrate of an organic light emitting diode (OLED), and will not be restricted herein. The second substrate 12 is disposed opposite to the first substrate 11. The materials of the first substrate 11 and the second substrate 12 may include glass, plastic or any other light-permeable material, and may be a flexible substrate. In addition, the first substrate 11 and the second substrate 12 may have the same material or different materials.

In this embodiment, the touch display panel 1a further includes a jointing element 15, wherein the jointing element 15, the first substrate 11 and the second substrate 12 form a receptacle R. The jointing element 15 may be an adhesive agent, and may also be referred to as a sealant, which may be, but without limitation to, a thermosetting sealant or UV-curing sealant. In addition, a display medium 16 may be disposed in the receptacle R and may be, for example, a liquid crystal material or an organic electroluminescent material. In addition, the touch electrode unit 13 is disposed on one side of the first substrate 11 which is away from the display medium 16. More particularly, in this embodiment, the conducting unit 14 electrically connects the touch electrode unit 13 to the second substrate 12.

In one example of the following description, the display medium 16 is the liquid crystal material, and the touch display panel 1 is a touch liquid crystal display panel.

FIG. 1C is a schematic top view showing the touch electrode unit of FIG. 1A. Referring to FIGS. 1A, 1B and 1C, the touch electrode unit 13 is disposed on one side of the first substrate 11 which is away from the second substrate 12. That is, when the touch electrode unit 13 is a film, the film is externally adhered to the first substrate 11. In addition, the electrode of the touch electrode unit 13 may also be directly disposed on the surface of the first substrate 11 which is away from the second substrate 12. The touch electrode unit 13 further includes a plurality of drive electrodes 131 and a plurality of sense electrodes 132, wherein the drive electrodes 131 and the sense electrodes 132 are substantially longitudinal, and the drive electrodes 131 interlace with the sense electrodes 132 to form a plurality of interlacing points (no electrical connection occurs because an insulation material is present between the electrodes) to sense the leakage current or capacitance, formed upon the touch or floating slide of the user on or over the surface of the touch display panel 1a, so that the touch position can be determined. In other embodiments, the drive electrodes 131 and the sense electrodes 132 may also be block-shaped or comb-shaped, and may be commonly form on a single-layer structure.

The material of the touch electrode unit 13 may be, for example but without limitation to, indium tin oxide (ITO), indium zinc oxide (IZO), fluorine doped tin oxide (FTO), aluminum doped zinc oxide (AZO), gallium doped zinc oxide (GZO) or a combination thereof.

FIG. 1D is a pictorial view showing another aspect of the touch electrode unit of FIG. 1A. In this aspect, the touch electrode unit 13 includes a first electrode layer 13a and a second electrode layer 13b. The first electrode layer 13a includes drive electrodes 131 arranged in a first direction. Similarly, the second electrode layer 13b also includes sense electrodes 132 arranged in a second direction, wherein the first electrode layer 13a and the second electrode layer 13b are disposed on different film materials.

Although the touch electrode units of different aspects have been provided hereinabove, those skilled in the art should understand that other touch electrode units of other aspects could be applied to the invention without affecting the main spirit of the invention.

As shown in FIGS. 1A and 1B, one side of the second substrate 12 close to the first substrate 11 has a conductive pattern layer 121. The conductive pattern layer 121 may be a multi-layer composite structure, which may include pixel electrodes, and data lines and scan lines interlacing with the data lines to control the display medium 16 to display a frame. In addition, the exposed portion, which is disposed on the conductive pattern layer 121 and not covered by the first substrate 11, may be formed with lead lines (not shown) connected to the data lines or scan lines.

The material of the conductive pattern layer 121 may be, for example but without limitation to, indium tin oxide (ITO), indium zinc oxide (IZO), fluorine doped tin oxide (FTO), aluminum doped zinc oxide (AZO), gallium doped zinc oxide (GZO), metal, graphene or any other conducting material.

As shown in FIGS. 1A and 1B, one end of the conducting unit 14 is connected to the touch electrode unit 13, and the other end of the conducting unit 14 is connected to the conductive pattern layer 121 of the second substrate 12. In this embodiment, the conducting unit 14 is disposed outside the first substrate 11, that is, disposed on a surface or sidewall of the first substrate 11, has one end extended and disposed on the touch electrode unit 13, and may be formed on the surface of the touch electrode unit 13 by way of printing, sputtering, coating or the like, and extends along the sidewall of the first substrate 11 to the conductive pattern layer 121 in order to electrically connect the touch electrode unit 13 to the conductive pattern layer 121. Herein, the conductive pattern layer 121 may further have patterned electrodes 1211 disposed correspondingly and electrically connected to the conducting units 14. In addition, the conducting unit 14 of this embodiment may be, for example but without limitation to, made of a material including metal, such as a conducting silver paint, a conductive film or an anisotropic conductive film (ACF).

It is to be noted that although all the conducting units 14 are commonly disposed on the same side of the first substrate 11 to electrically connect the touch electrodes in the same axial direction of the touch electrode unit 13 to the patterned electrode 1211 in this exemplary embodiment, the other side of the first substrate 11 may also have the similar arrangement to electrically connect the touch electrodes of the touch electrode unit 13 (e.g., the drive electrodes 131 shown in FIG. 1C) in the other axial direction to the conductive pattern layer 121. Of course, the touch electrodes of the touch electrode unit 13 in different axial directions may be configured so that the layouts to be connected to the external device in various axial directions may be integrated into one single axial direction, and that the structures, such as the conducting units 14 and the patterned electrodes 1211, may be disposed on one only side of the first substrate 11.

As shown in FIGS. 1A and 1B, the touch display panel la may further include a touch control integrated circuit (IC) or a touch sensor IC 18, which is disposed on the second substrate 12 and is electrically connected to the conducting unit 14 through the conductive pattern layer 121 of the second substrate 12. In other words, the touch control IC 18 is directly disposed on the conductive pattern layer 121 by way of chip on glass (COG). Consequently, the touch electrode unit 13 can be electrically connected to the conductive pattern layer 121 and electrically connected to the touch control IC 18 through the conducting unit 14.

FIG. 1E is a cross-sectional view showing another aspect of a touch display panel according to the first embodiment of the invention. In the aspect of FIG. 1E, the touch display panel 1b may have a protection substrate 17 disposed on the touch electrode unit 13. The protection substrate 17 is a light-permeable substrate made of the material of glass or plastic, for example. Furthermore, the protection substrate 17 is adhered to the touch electrode unit 13 through an optical adhesive layer G. The optical adhesive layer G can cover a portion of the conducting unit 14 and is disposed on a portion of the upper surface of the touch electrode unit 13. The provision of the protection substrate 17 can prevent the damage from being caused when the user directly presses the touch electrode unit 13.

FIG. 1F is a cross-sectional view showing still another aspect of a touch display panel according to the first embodiment of the invention. As shown in FIG. 1F, the touch display panel 1c in this embodiment may be a touch liquid crystal display panel. So, a backlight source module LM may be disposed on one side of the second substrate 12, particularly on one side of the second substrate 12 which is away from the first substrate 11, to function as a touch display apparatus. It is to be noted that whether the backlight source module LM is provided or not is determined according to the material of the display medium 16. For example, when the display medium 16 is a self lighting material, such as the organic electroluminescent material, no backlight source module LM is needed. In addition, the backlight source module LM may be, for example but without limitation to, a bottom lighting light source or a side-lighting light source.

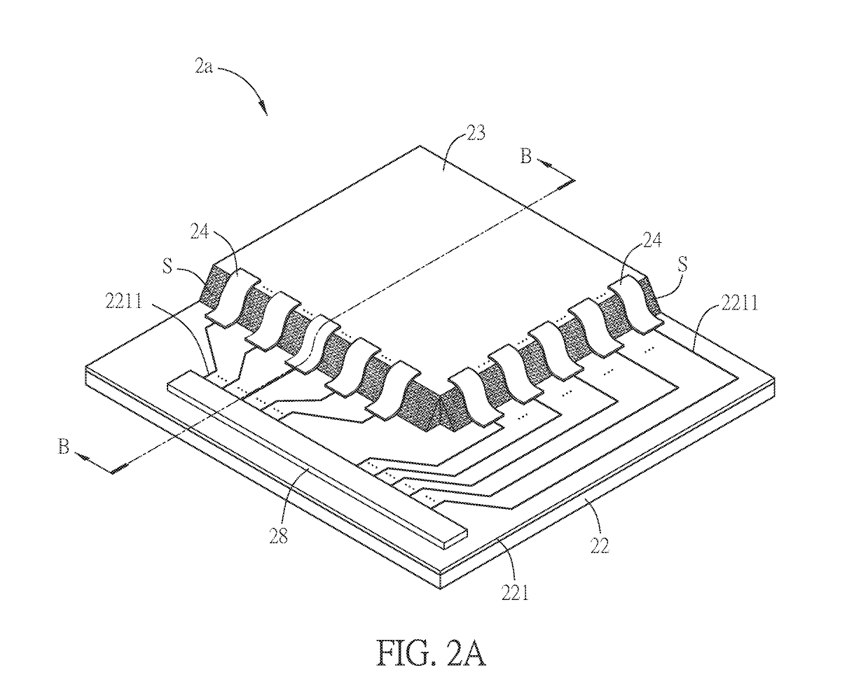

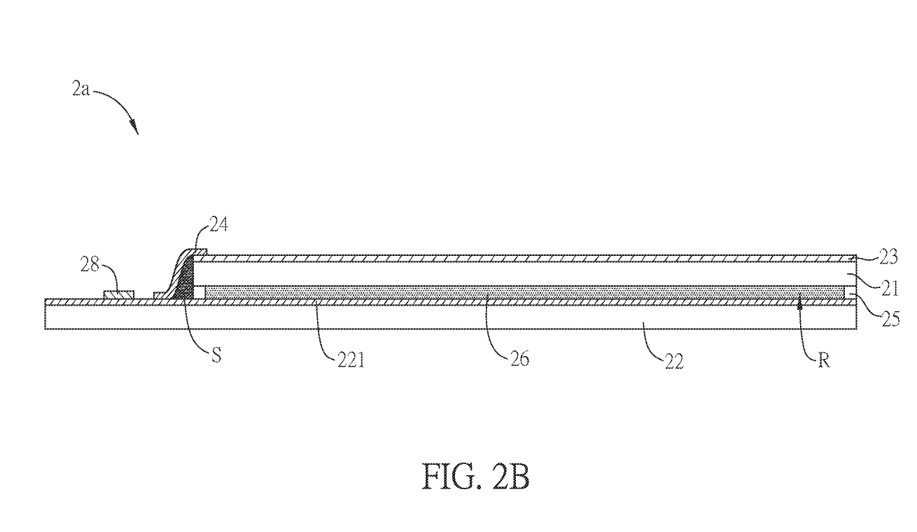

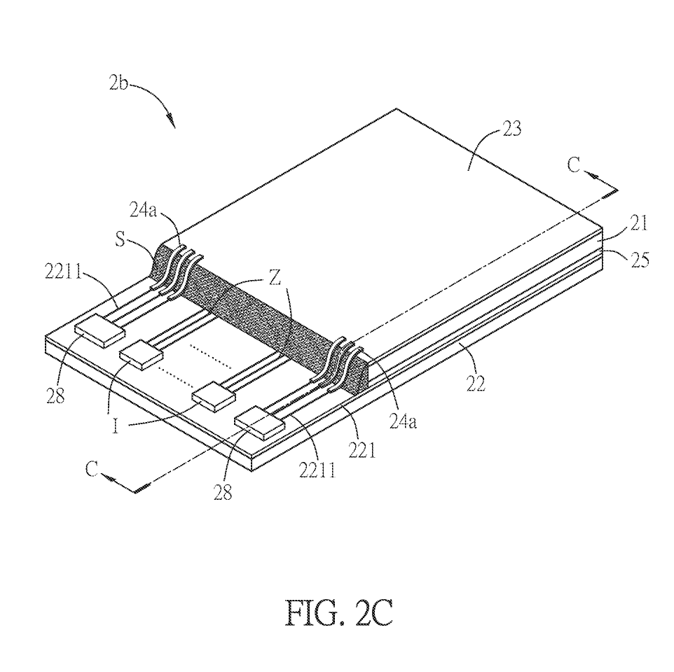

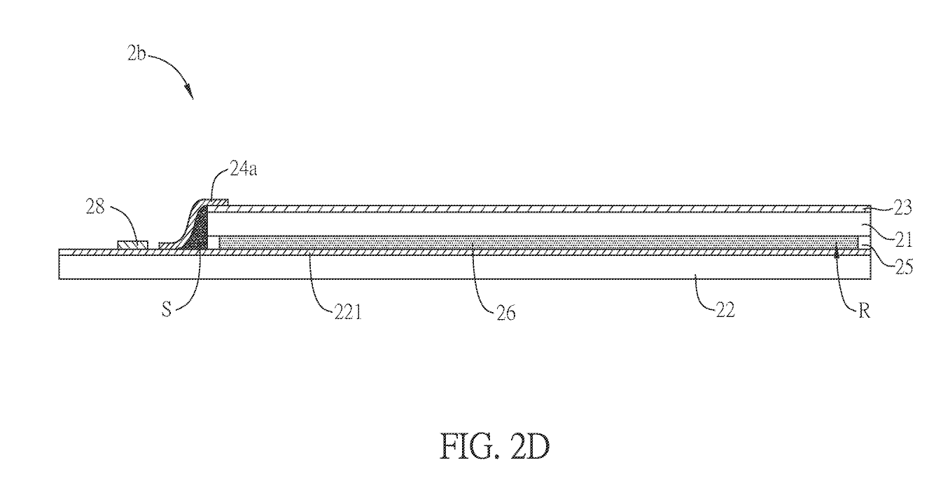

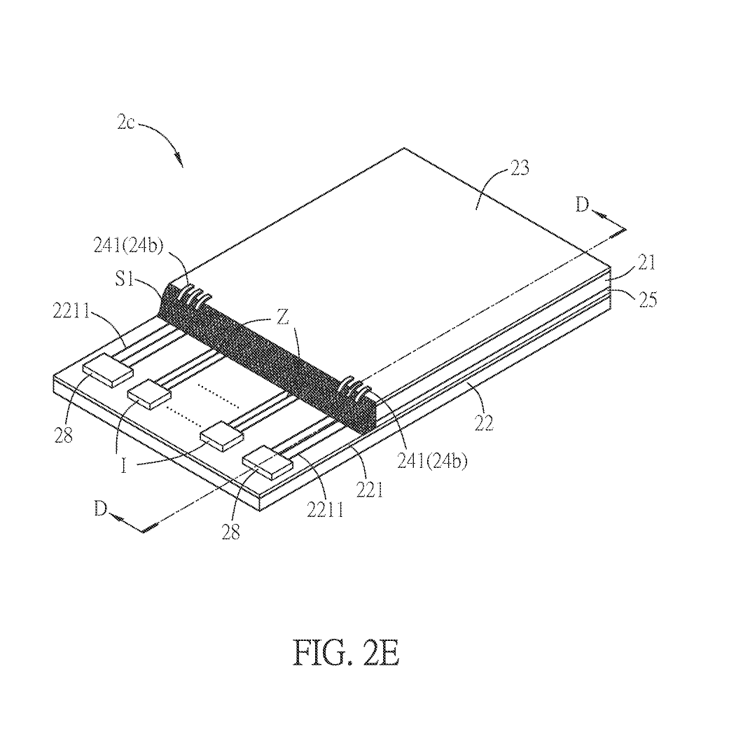

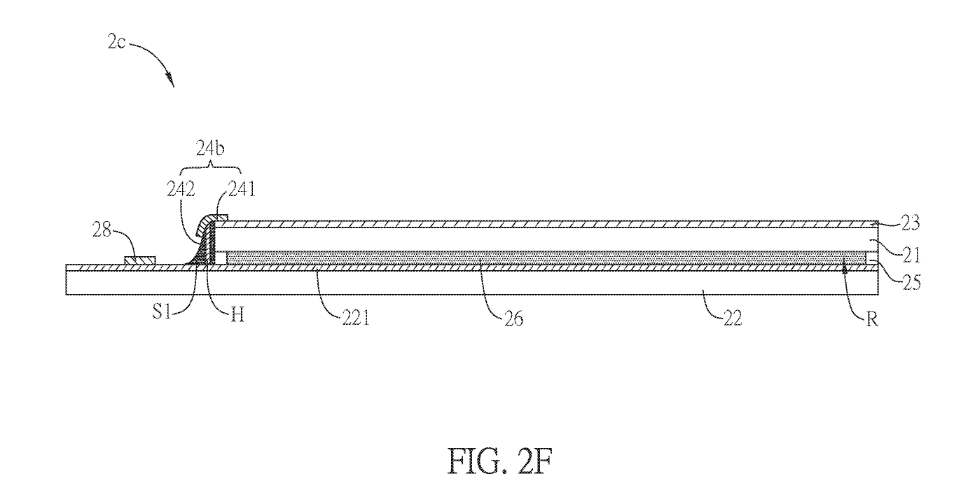

FIG. 2A is a pictorial view showing an aspect of a touch display panel according to a second embodiment of the invention. FIG. 2B is a cross-sectional view taken along a line B-B of the touch display panel of FIG. 2A. Referring to FIGS. 2A and 2B of this embodiment, the materials of and the connection relationships between the first substrate 21, the second substrate 22, the jointing element 25 and the display medium 26 may be found in the first embodiment, and detailed descriptions thereof will be omitted. The touch display panel 2a further includes a support S. The support S is formed on the interface between the surface of the second substrate 22 and the side surface of the first substrate 21. The material of the support S may be, for example but without limitation to, the light-curing resin or thermosetting resin. Herein, the support S may have an inclined surface, and the conducting units 24 are formed on the support S. Thus, an angle ranging from 0 to 90 degrees is formed between the conducting unit 24 and the second substrate 22.

In this embodiment, the conducting unit 24 may be formed on the surface of the support S by way of, for example but without limitation to, printing, sputtering, coating or the like. In addition, the conducting unit 24 has one end connected to the touch electrode unit 23, and the other end connected to the conductive pattern layer 221, so that the touch electrode unit 23 is electrically connected to the conductive pattern layer 221, and is electrically connected to the touch control IC 28 through the patterned electrode 2211.

It is to be noted that, in this aspect, the touch display panel 2a includes a plurality of conducting units 24, and the touch electrode unit 23 includes a plurality of first direction electrodes and a plurality of second direction electrodes (see FIG. 1C or 1D), wherein the first direction electrodes and the second direction electrodes are electrically connected to the conductive pattern layer 221 on different lateral sides of the second substrate 22 through the conducting units 24, respectively. In other words, the touch display panel 2a has the conducting units 24 disposed on two neighboring sides of the first substrate 21 to electrically connect the electrodes of the touch electrode unit 23 with different directions to the conductive pattern layer 221. Furthermore, the conducting units 24 on two sides of the first substrate 21 are electrically connected to the touch control IC 28 through the patterned electrodes 2211. It is to be noted that two neighboring sides of the first substrate 21 are described as an example herein. In other aspects, however, it is also possible to dispose the conducting units 24 on three or four different sides of the first substrate 21, and the conducting units 24 are electrically connected to the touch control ICs 28 through the patterned electrodes 2211.

FIG. 2C is a pictorial view showing another aspect of a touch display panel according to the second embodiment of the invention. FIG. 2D is a cross-sectional view taken along a line C-C of the touch display panel of FIG. 2C. As shown in the aspect of FIGS. 2C and 2D, the conducting units 24a of the touch display panel 2b are disposed on two sides of the support S, and the corresponding touch control ICs 28 are disposed on the conductive pattern layer 221. In addition, multiple drive integrated circuits I can be disposed on the conductive pattern layer 221, and the lead lines Z of the scan lines can be electrically connected to the drive ICs I.

It is to be particularly noted that only the connection of the lead line Z of the scan line is depicted in FIG. 2C. However, those skilled in the art may understand that the data line may also be electrically connected to the drive IC I in a manner similar to the lead line Z of the scan line.

FIG. 2E is a pictorial view showing still another aspect of a touch display panel according to the second embodiment of the invention. FIG. 2F is a cross-sectional view taken along a line D-D of the touch display panel of FIG. 2E. As shown in FIGS. 2E and 2F, the conducting unit 24b in this aspect includes an outer conducting member 241 and an inner conducting member 242, and the support 51 of the touch display panel 2c has through holes H corresponding to the conducting units 24b. The outer conducting member 241 is disposed on the support 51, that is, disposed outside the support 51. The inner conducting member 242 is disposed in the through hole H, that is, disposed inside the support 51. The outer conducting member 241 is electrically connected to the touch electrode unit 23 and the inner conducting member 242; and the inner conducting member 242 is electrically connected to the outer conducting member 241 and the conductive pattern layer 221. Consequently, the touch electrode unit 23 may be electrically connected to the conductive pattern layer 221 through the outer conducting member 241 of the conducting unit 24b and the inner conducting member 242 in the through hole H. In addition, the outer conducting member 241 and the inner conducting member 242 may be made of the same material or different materials, and will not be restricted herein.

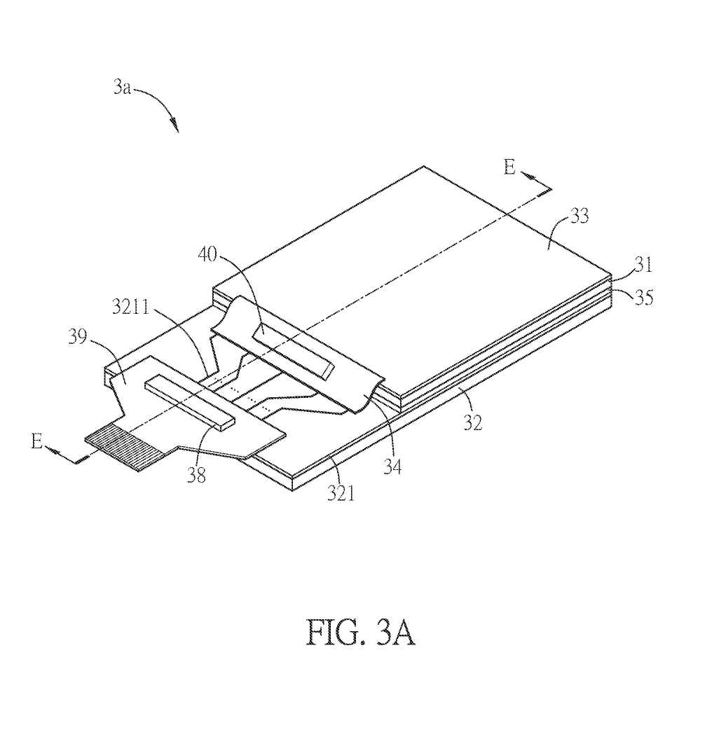

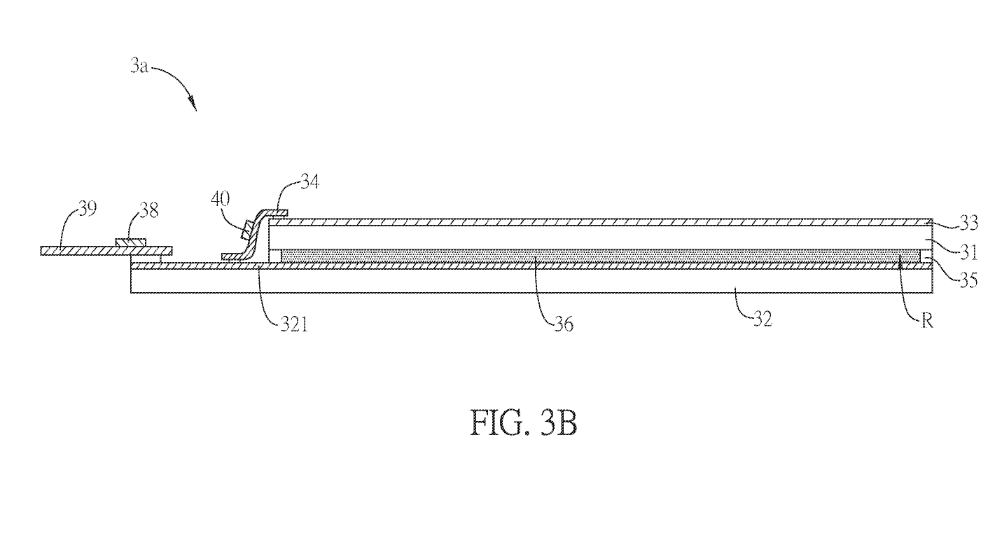

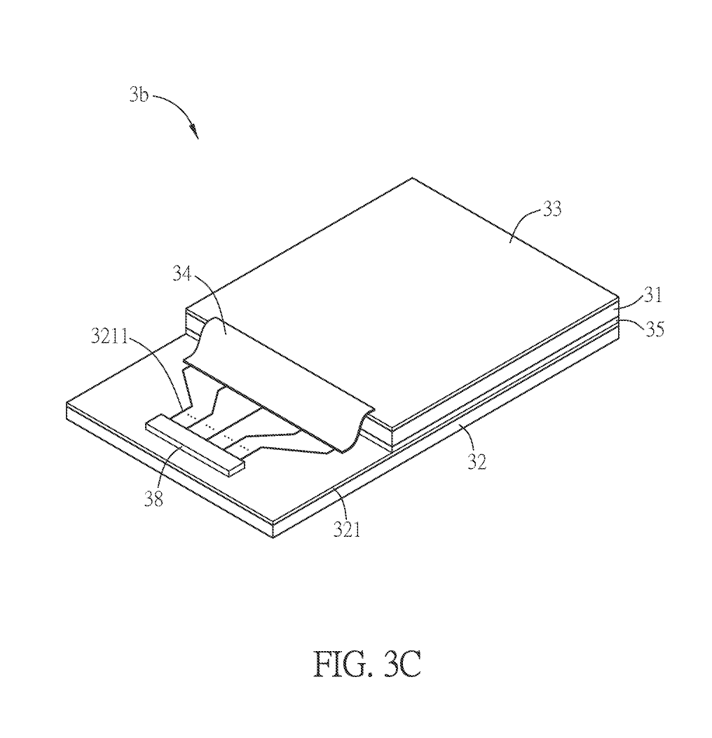

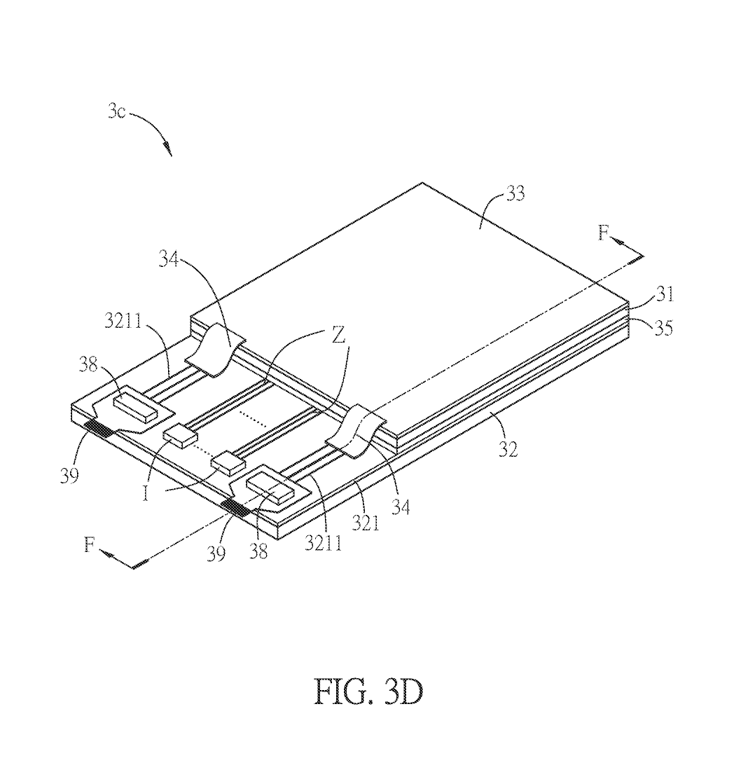

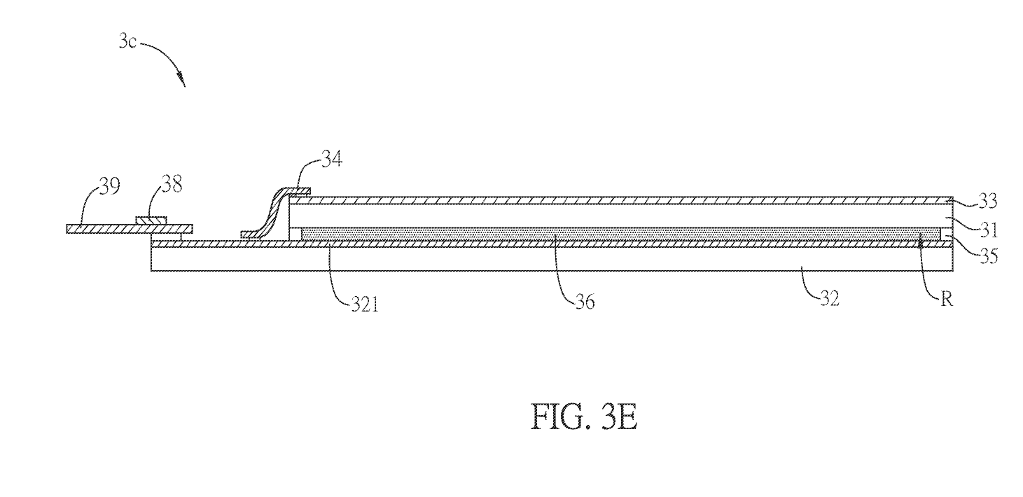

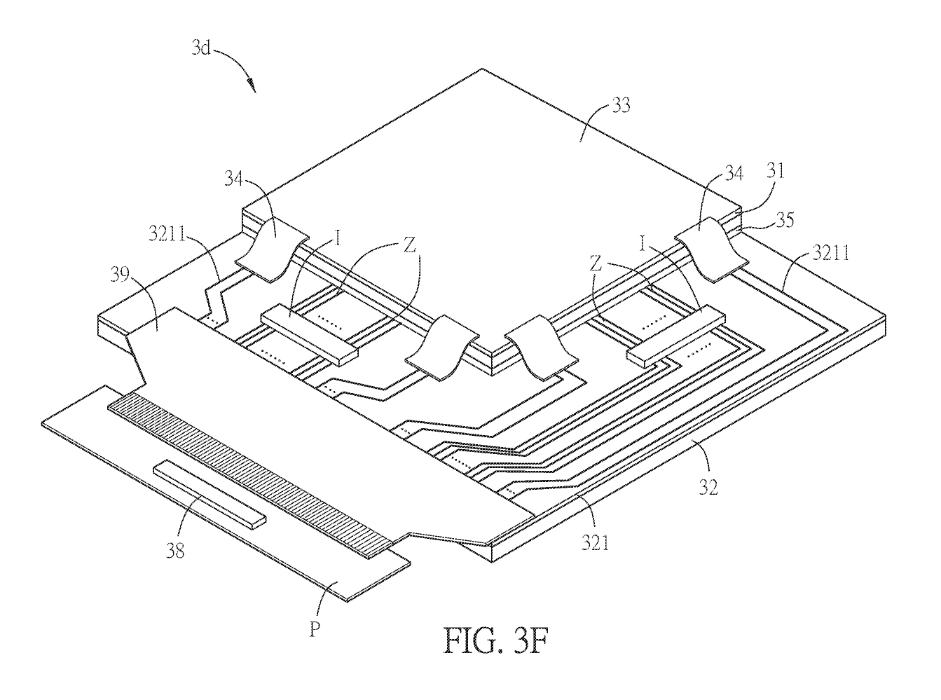

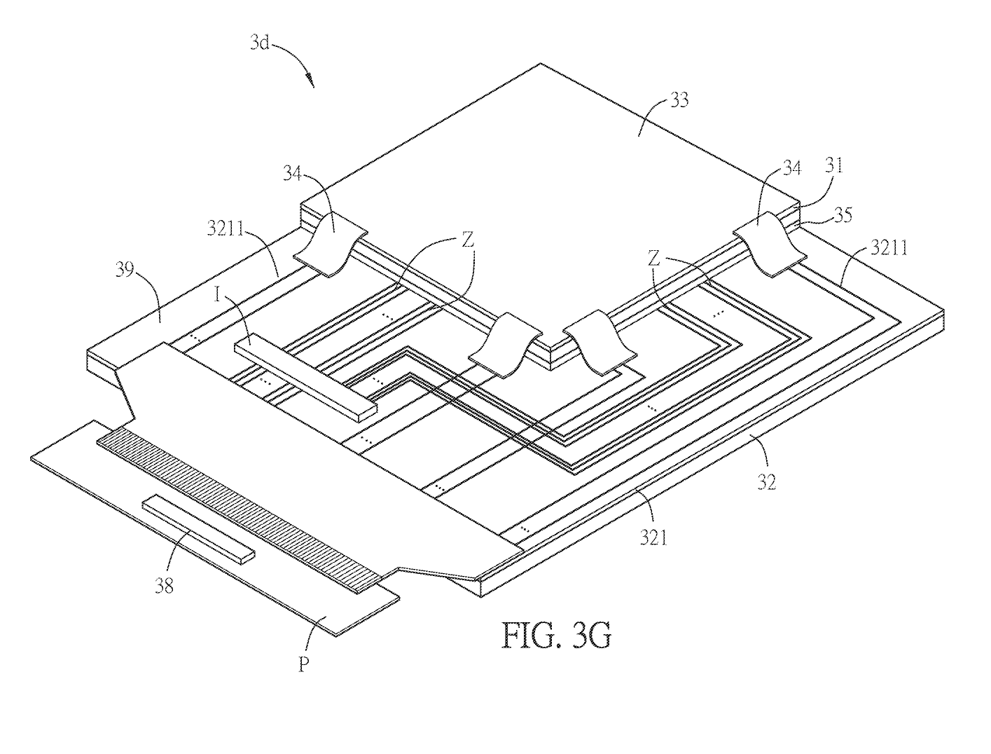

FIG. 3A is a pictorial view showing an aspect of a touch display panel according to a third embodiment of the invention. FIG. 3B is a cross-sectional view taken along a line E-E of the touch display panel of FIG. 3A. Referring to FIGS. 3A and 3B, the materials of and the connection relationships between the first substrate 31, the second substrate 32, the jointing element 35 and the display medium 36 may be found in the first embodiment, and detailed descriptions thereof will be omitted. The conducting unit 34 of the touch display panel 3a may include a flexible printed circuit (Flexible Printed Circuit, FPC), a data bus or rigid-flex board.

In this embodiment, the conducting unit 34 is a flexible printed circuit, and has one end connected to the touch electrode unit 33 and the other end connected to the conductive pattern layer 321 of the second substrate 32. Specifically, the flexible printed circuit may have edge connectors (also referred to as golden fingers), wherein the edge connector has a portion correspondingly adhered to the touch electrode unit 33, and the other portion correspondingly adhered to the conductive pattern layer 321 to electrically connect the touch electrode unit 33 to the conductive pattern layer 321.

In this embodiment, the touch display panel 3a may further include an electrical connection member 39 disposed on the conductive pattern layer 321 of the second substrate 32, wherein the touch control IC 38 is disposed on the electrical connection member 39 so that the conductive pattern layer 321 may be electrically connected to the touch control IC 38 through the electrical connection member 39. Specifically, the touch control IC 38 is packaged on the electrical connection member 39 by way of chip on film (COF) processes, so that the touch control IC 38 can be electrically connected to the touch electrode unit 33 through the conducting unit 34. The electrical connection member 39 may be, for example but without limitation to, a data bus, a FPC board or a rigid-flex board. Consequently, the integrated circuit, which is disposed on the second substrate 32 and controls the display medium 36, may be shared with the touch control IC 38 for controlling the touch electrode unit 33, and the two ICs can be integrated into one single integrated circuit to decrease the material cost. The display medium 36 is disposed in the receptacle R formed by the jointing element 35, the first substrate 31 and the second substrate 32, wherein the description of the display medium 36 may be found in the above-mentioned embodiment, and detailed descriptions thereof will be omitted.

In addition, it is also possible to adopt the COF processes to package the touch control ICs 18 and 28 on the electrical connection member 39 in the first and second embodiments. It is to be noted that the drive IC I of the first and second embodiments may be similarly disposed on the electrical connection member 39, or may be integrated with the touch control ICs 18 and 28 to form one single integrated circuit.

In practice, an integrated circuit may also be disposed on the conducting unit 34. That is, the touch control IC 38 may be integrated on the conducting unit 34 to drive/receive the signal generated by the touch electrode unit 33, and thus judge the touch position (or gesture) of the user on the outer surface of the touch display panel 3a.

FIG. 3C is a pictorial view showing another aspect of a touch display panel according to the third embodiment of the invention. As shown in the aspect of FIG. 3C, no integrated circuit is disposed on the flexible printed circuit (i.e., the conducting unit 34) of the touch display panel 3b, and the flexible printed circuit only functions to electrically connect the touch electrode unit 33 to the conductive pattern layer 321.

FIG. 3D is a pictorial view showing still another aspect of a touch display panel according to the third embodiment of the invention. FIG. 3E is a cross-sectional view taken along a line F-F of the touch display panel of FIG. 3D. As shown in the aspect of FIGS. 3D and 3E and as shown in FIG. 2C, the conducting units 34 of the touch display panel 3c are disposed on two sides of the sidewall of the first substrate 31. Other connection relationships may be easily understood by those skilled in the art, and detailed descriptions thereof will be omitted.

FIG. 3F is a schematic view showing yet still another aspect of a touch display panel according to the third embodiment of the invention. As shown in the aspect of FIG. 3F, the touch display panel 3d may further include a printed circuit board (PCB) P, which is electrically connected to the electrical connection member 39, wherein the touch control IC 38 is disposed on the printed circuit board P. Herein, the touch electrode unit 33 may be electrically connected to the touch control IC 38 disposed on the printed circuit board P through the conducting unit 34, the conductive pattern layer 321 and the electrical connection member 39.

In addition, the touch display panel 3d of this aspect includes a plurality of conducting units 34, and the touch electrode unit 33 includes a plurality of first direction electrodes and a plurality of second direction electrodes (see FIG. 1C or 1D), wherein the first direction electrodes and the second direction electrodes are electrically connected to the conductive pattern layer 321 on different lateral sides of the second substrate 32 through the conducting units 34, respectively. In other words, the touch display panel 3d has the conducting units 34 disposed on two neighboring sides of the first substrate 31 to electrically connect the electrodes of the touch electrode unit 33 with different directions to the conductive pattern layer 321. Furthermore, the conducting units 34 on two sides of the first substrate 31 are electrically connected to the touch control IC 38 through the patterned electrodes 3211 and the electrical connection members 39, respectively. It is to be noted that two neighboring sides of the first substrate 31 are described as an example herein. In other aspects, however, it is also possible to dispose the conducting units 34 on three or four different sides of the first substrate 31, and the conducting units 34 are electrically connected to the touch control ICs 38 through the patterned electrodes 3211 and the electrical connection members 39.

FIG. 3G is a schematic view showing yet still another aspect of a touch display panel according to the third embodiment of the invention. As shown in FIG. 3G, this aspect differs from the aspect of FIG. 3F in that, in a small-size panel, the lead lines Z on the different lateral sides of the second substrate 32 are electrically connected to the same drive IC I. Of course, in this aspect, the lead lines Z and the conductive pattern layer 3211 may be disposed on different layers.

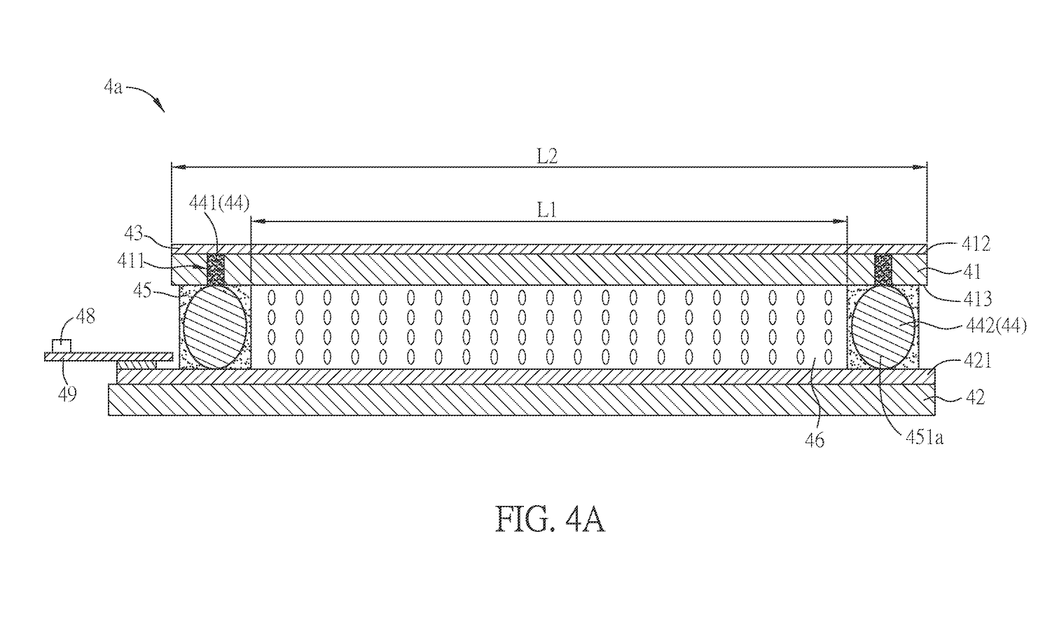

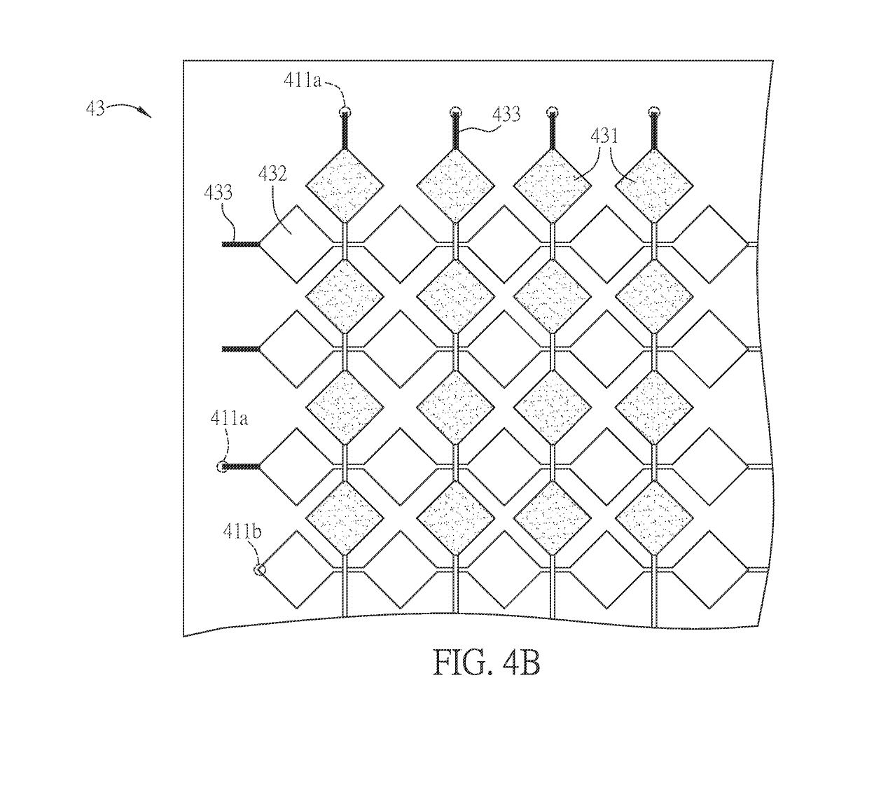

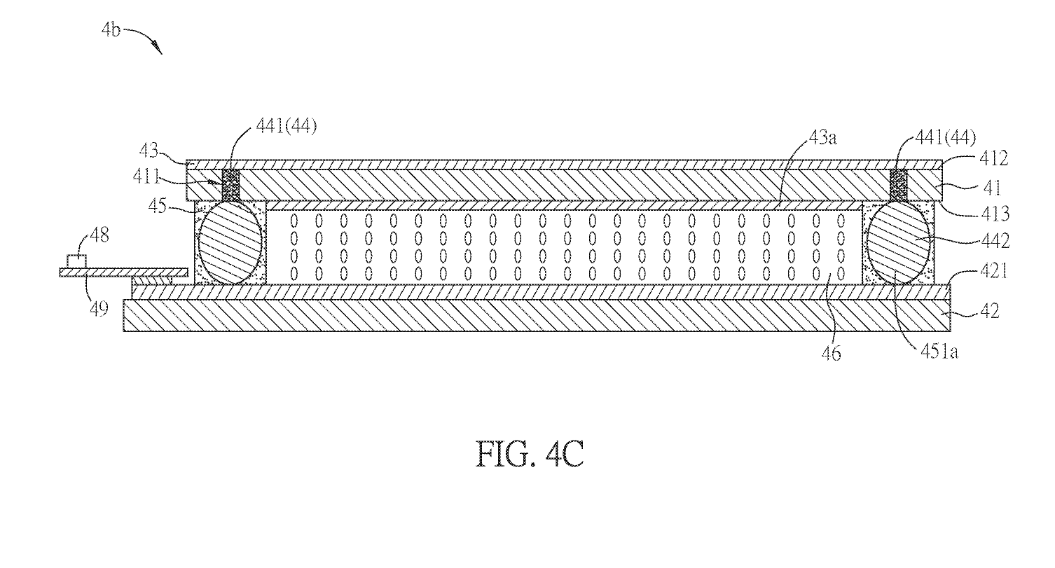

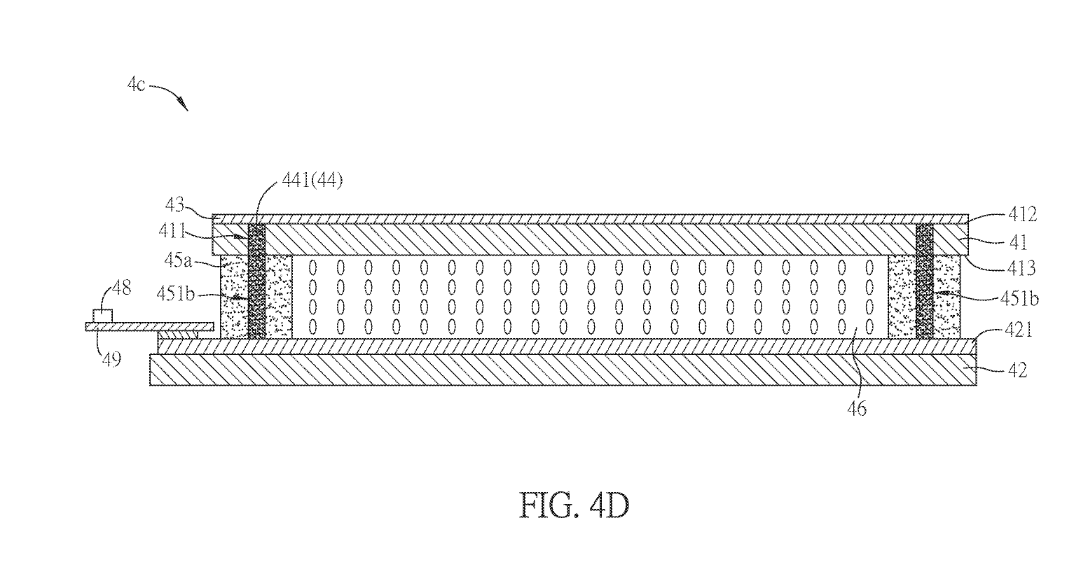

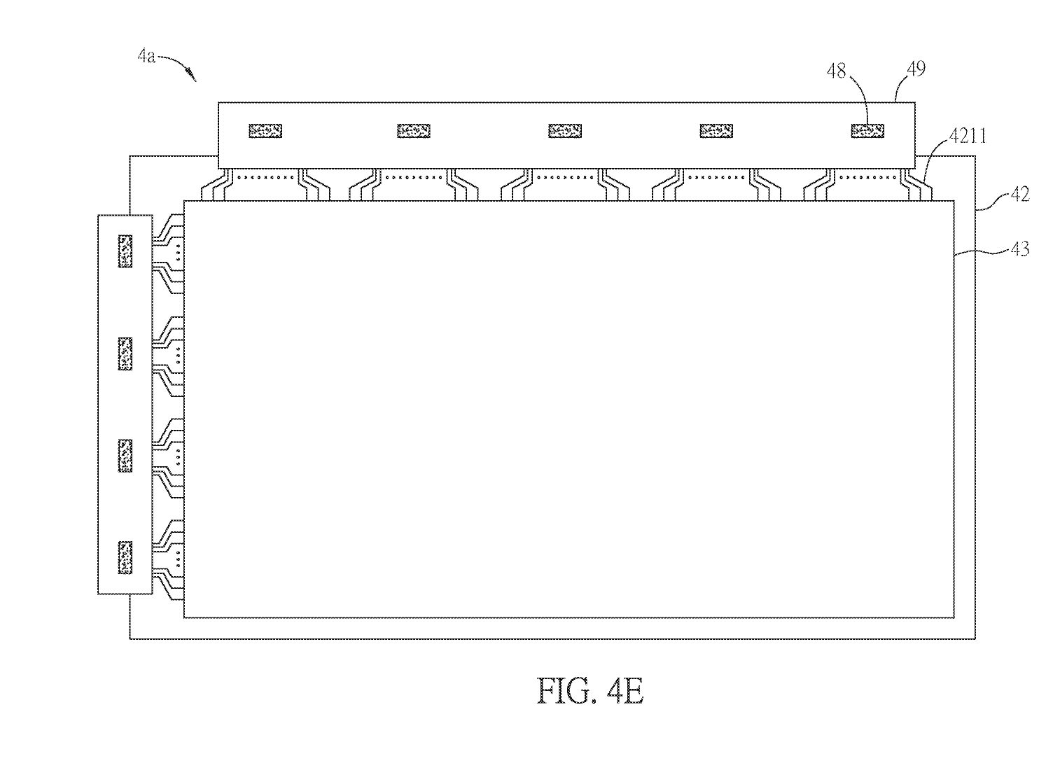

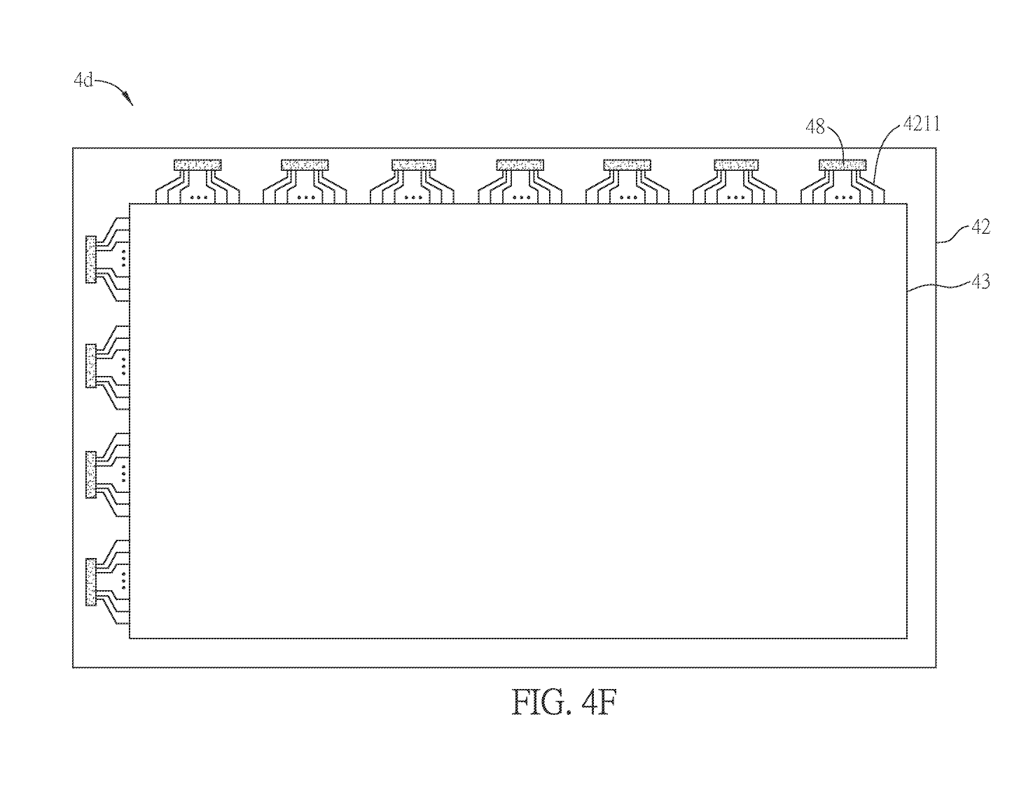

FIG. 4A is a cross-sectional view showing a touch display panel according to a fourth embodiment of the invention. Referring to FIG. 4A, the touch display panel 4a includes a first substrate 41, a second substrate 42 and a touch electrode unit 43. In this embodiment, the first substrate 41 has a plurality of first through holes 411, a first surface 412 and a second surface 413 opposite to the first surface 412. The first through holes 411 penetrate through the first surface 412 and the second surface 413. That is, the first through holes 411 penetrate through the first substrate 41 so that the first surface 412 and the second surface 413 can be interconnected with each other the first through holes 411.

In this embodiment, the conducting unit 44 includes a first conducting material 441 disposed on the inside or hole wall of the first through hole 411. In the glass perforation process, vertically conductive via holes may be formed in the first substrate 41, and then the first conducting material 441 is disposed on the hole wall of the via hole or filled into the inside of the via hole to form the conducting first through holes 411. In other words, the first conducting material 441 and the first through hole 411 have an integrated structure so that the first through hole 411 has the conducting property. The first conducting material 441 may be, for example but without limitation to, a metal material, a conducting silver paint or various conductive films, and is preferably an anisotropic conductive film (ACF) to ensure that the electrode on the surface of the touch electrode unit 43 can be electrically connected to the second surface 413 of the first substrate 41 through the first through hole 411. The electrode of the touch electrode unit 43 may be electrically connected to the second substrate 42 or other elements on one side of the second surface 413 of the first substrate 41 through the first conducting material 441 of the first through hole 411.

FIG. 4B is a schematic top view showing the touch electrode unit of FIG. 4A. Referring to FIGS. 4A and 4B, the touch electrode unit 43 of this embodiment includes a plurality of drive electrodes 431 and a plurality of sense electrodes 432. The drive electrodes 431 and the sense electrodes 432 are longitudinal and interlace with each other to form a dual-layer structure with a plurality of interlacing points (no electrical connection is present because an insulation material is disposed therebetween) to sense the leakage current formed when the user touches the surface of the touch display panel 4a. The drive electrodes 431 and the sense electrodes 432 on the touch electrode unit 43 may be electrically connected to the second surface 413 of the first substrate 41 through the first through holes 411. FIG. 4C is a schematic view showing another implementation of a touch display panel according to the fourth embodiment of the invention. In addition, as shown in FIG. 4C, the drive electrode 431 and the sense electrode 432 of the touch display panel 4b interlace with each other to form the dual-layer structure, in which one touch electrode unit 43 is disposed on one side of the first substrate 41, and the other touch electrode unit 43a is disposed on the other side of the first substrate 41. In another embodiment, the drive electrodes 431 and the sense electrodes 432 may be block-shaped and commonly form a single-layer structure.

Referring to FIGS. 4A and 4B, the touch electrode unit 43 of the fourth embodiment has a plurality of metal wires 433, which are extended from the touch electrode unit 43, such as the electrode edges of the drive electrodes 431 and the sense electrodes 432, to the first through hole 411a (the dashed lines represent the corresponding positions of the first through holes). The connection of the metal wire 433 to the first through hole 411a enables the drive electrode 431 and the sense electrode 432 to be electrically connected to the second surface 413 of the first substrate 41 through the first through hole 411. In another embodiment, it is of course possible that the touch electrode unit 43 has no metal wire 433, and the first through hole 411b (the dashed lines represent the corresponding positions of the first through holes) is correspondingly disposed around the drive electrode 431 and the sense electrode 432, so that the drive electrode 431 and the sense electrode 432 can be electrically connected to the second surface 413 of the first substrate 41 directly through the first through hole 411b.

In addition, as shown in FIG. 4A, the jointing element 45 of this embodiment has a second through hole 451a, and the conducting unit 44 further includes a second conducting material 442, which may be, for example but without limitation to, a metal material, a conducting silver paste or various conductive films, and is preferably a ball-shaped anisotropic conducting material, so that the touch electrode unit 43 can be electrically connected to the second substrate 42 through the first conducting material 441 of the first through hole 411 and the second conducting material 442 of the second through hole 451a. In addition, in this embodiment, the second conducting material 442 is a ball-shaped anisotropic conducting material, so the jointing elements 45 are conductive only along the vertical direction, and are non-conductive along the horizontal direction because they are covered by the adhesive agent.

FIG. 4D is a schematic view showing still another implementation of a touch display panel according to the fourth embodiment of the invention. As shown in FIG. 4D, the second through hole 451b of the touch display panel 4c in this embodiment may be formed with the vertically conductive via hole at the jointing element 45a. Specifically, the via hole is formed by way of drilling, and then filled with the conducting material similar to the first conducting material 441 and the second conducting material 442 (FIG. 4A), which may be, for example but without limitation to, the metal material, the conducting silver paint or various conductive films, such as the anisotropic conductive film, to form the second through hole 451b with the conducting property. At least a portion of the second through hole 451b is disposed corresponding to one of the first through holes 411. That is, the positions of the first through holes 411 correspond to the positions of the second through holes 451b, so that the first conducting material 441 of the first through hole 411 may be interconnected with the conducting material filled into the second through hole 451b, and that the touch electrode unit 43 may be electrically connected to the conductive pattern layer 421 of the second substrate 42 through the first through hole 411 and the second through hole 451b of the jointing element 45a.

The interconnection positions between the first through holes 411 and the second through holes 451b may be continuous or discontinuous. Specifically, in this embodiment, the aperture of the second through hole 451b is substantially equal to the aperture of the corresponding first through hole 411. In addition, when the second through holes 451b and the first through holes 411 are disposed correspondingly, the continuous connection portions are formed. Of course, in another embodiment, the aperture of the second through hole 451b may also be different from that of the corresponding first through hole 411 to form the discontinuous connection portions. In this case, only at least a portion of the second through hole 451b and the first through holes 411 are disposed correspondingly, so that the touch electrode unit 43 can be electrically connected to the second substrate 42 through the first through holes 411 and the second through holes 451b.

As shown in FIGS. 4A and 4D, at least a portion of the first through holes 411 are disposed in the contact regions between the first substrate 41 and the jointing elements 45 and 45a. For example, all the first through holes 411 may be disposed in the contact regions between the first substrate 41 and the jointing elements 45 and 45a. Alternatively, a portion of the first through holes 411 is disposed in the contact region between the first substrate 41 and the jointing element 45, and the other portion of the first through holes 411 is disposed outside the jointing elements 45 and 45a. In this embodiment, all the first through holes 411 are disposed in the contact regions between the first substrate 41 and the jointing elements 45 and 45a. Preferably, at least a portion of the first through holes 411 is disposed in the contact region with the second conducting material 442 (FIG. 4A), or in the contact region with the second through hole 451b (FIG. 4D).

FIG. 4E is a schematic top view showing the touch display panel of FIG. 4A. Referring to FIGS. 4A and 4E, the touch display panel 4a further includes a touch control IC 48 and an electrical connection member 49, wherein this embodiment adopts the COF process to package the touch control IC 48 on the electrical connection member 49, so that the touch control IC 48 can be electrically connected to the touch electrode unit 43 through the first conducting material 441 and the second conducting material 442 of the conducting unit 44. In addition, the descriptions of the touch control IC 48 and the electrical connection member 49 may be found in the above-mentioned embodiments, so detailed descriptions thereof will be omitted. Thus, with the design of the first through holes 411 of this embodiment, the touch electrode unit 43 can be electrically from the first surface 412 of the first substrate 41 to the second surface 413 through the first through holes 411, and then be electrically connected to the conductive pattern layer 421 of the second substrate 42 through the jointing element 45, and be electrically connected to the touch control IC 48 of the touch display panel 4a through the patterned electrodes 4211. Consequently, the material cost can be decreased, and the space occupied by the electrical connection member 49 can be decreased.

FIG. 4F is a schematic view showing another implementation of a touch control integrated circuit of the touch display panel of FIG. 4E. As shown in FIG. 4F, in the touch display panel 4d of this embodiment, the touch control IC 48 may also be directly disposed on the second substrate 42. That is, the COF technology is adopted to direct dispose the touch control IC 48 on the surface of the second substrate 42, and the electrical connection may also be achieved through the first through hole 411 and the second through hole 451a (see FIG. 4A). Similarly, the touch electrode unit 43 may be electrically connected to the second substrate 42 directly through the first through hole 411 and the second through hole 451a and thus be electrically connected to the touch control IC 48 of the touch display panel 4d.

In addition, as shown in FIG. 4A, the area of the display surface of the touch display panel 4a is substantially the corresponding area where the display medium 46 is disposed, and has the width L1. The layout area of the touch electrode unit 43 is the area of the touch surface and has a maximum width that may be the width L2 of the first substrate 41, as shown in the drawing, wherein the width L2 is greater than the width L1. That is, the area of the touch surface is larger than the area of the display surface. Therefore, when the user performs the operation on the touch surface of the touch display panel 4a, the touch operation range thereof is valid from the region outside the display surface, and the touch operation outside the sealant (i.e., the jointing element 45) (outside the region of the display surface) may further be detected.

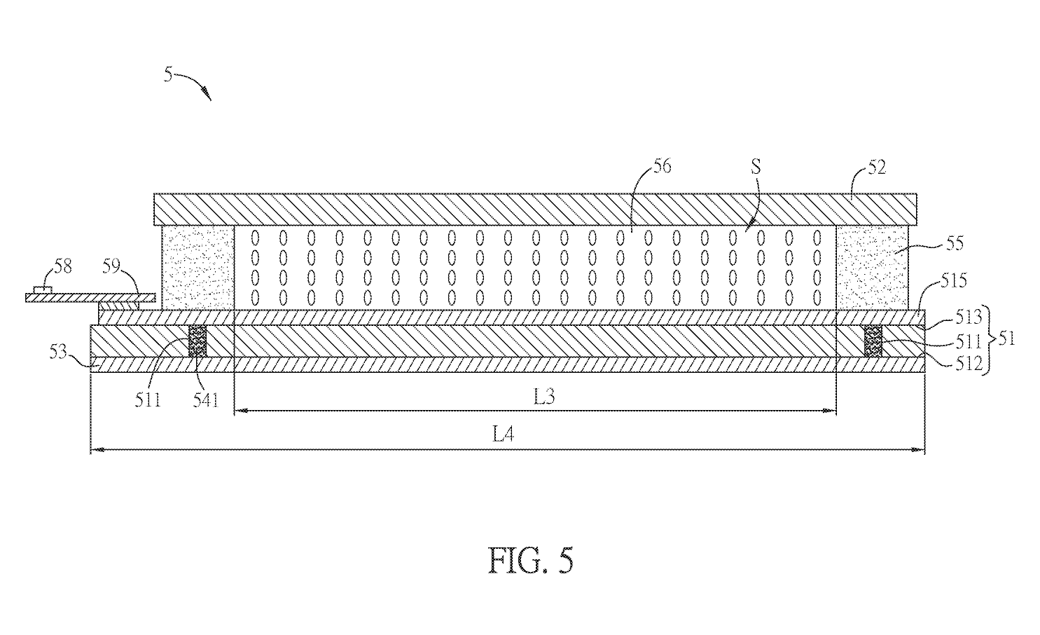

FIG. 5 is a cross-sectional view showing a touch display panel according to a fifth embodiment of the invention. As shown in FIG. 5, the touch display panel 5 of the fifth embodiment is also described with reference to a liquid crystal display panel as an example, the first substrate 51 of the fifth embodiment is a thin film transistor substrate, the second substrate 52 is a color or monochrome filter substrate, and the first substrate 51 is closer to the user (light output side). This embodiment does not intend to restrict the dimensional relationship between the first substrate 51 and the second substrate 52 (no restriction is made to other embodiments). In other words, the size of the first substrate 51 may also be smaller than, equal to or greater than the size of the second substrate 52. In this example, the size of the first substrate 51 is greater than the size of the second substrate 52, the touch electrode unit 53 corresponds to the first substrate 51 and is disposed on the lower surface of the first substrate 51, and the conductive pattern layer 515 is disposed on the surface of the first substrate 51 close to the display medium 56. In this embodiment, the size of the first substrate 51 is greater than the size of the second substrate 52. Thus, in addition to the fact that the width L4 of the touch surface is greater than the width L3 of the display surface, the difference between the widths L4 and L3 becomes more significant than the fourth embodiment. Thus, when the user performs the operation on the touch surface of the touch display panel 5, the touch operation range thereof is valid from the region outside the display surface, and the touch operation over the larger range outside the sealant may further be detected.

Similarly, the first substrate 51 and the second substrate 52 are disposed opposite to each other, wherein the first substrate 51 also has a plurality of first through holes 511, a first surface 512 and a second surface 513 opposite to the first surface 512, wherein the first through hole 511 penetrates through the first surface 512 and the second surface 513. Preferably, a first conducting material 541 may also be disposed on the inside or hole wall of the first through hole 511 to form the conducting first through hole 511 to ensure that the touch electrode unit 53 can be electrically connected from the first surface 512 to the second surface 513 of the first substrate 51 through the first through hole 511.

In the fifth embodiment, the second surface 513 of the first substrate 51 (thin film transistor substrate) has a plurality of pixel electrodes and data lines and scan lines interlacing with each other, and the first substrate 51 may further have a conductive pattern layer 515, which is formed on the first substrate 51 and disposed on the same side as the second surface 513, wherein the drive electrodes and the sense electrodes of the touch electrode unit 53 (details thereof can be obtained from the fourth embodiment) can be electrically connected to the conductive pattern layer 515 through the first through holes 511. Furthermore, the touch display panel 5 may further include a touch control IC 58 and an electrical connection member 59. In the fifth embodiment, one end of the electrical connection member 59 is electrically connected to the conductive pattern layer 515, and the touch control IC 58 is packaged on the electrical connection member 59. The touch electrode unit 53 may be electrically connected to the second surface 513 of the first substrate 51 through the first through holes 511, and is electrically connected to the conductive pattern layer 515 and then be electrically connected to the touch control IC 58 of the touch display panel 5. In addition, in another embodiment, the touch control IC 58 may also be directly disposed, by way of COG, for example, on the second surface 513 of the first substrate 51, and the touch electrode unit 53 is electrically connected to the touch control IC 58 through the first through holes 511, wherein the details thereof may be found in the fourth embodiment, and detailed descriptions thereof will be omitted. Alternatively, the drive integrated circuit 58 is directly disposed on a rigid circuit board, so that one end of the electrical connection member 59 is electrically connected to the conductive pattern layer 515 of the first substrate 51, and the other end of the electrical connection member 59 is electrically connected to the rigid circuit board.

In addition, the touch display panel 5 similarly further includes a jointing element 55 for jointing the first substrate 51 and the second substrate 52 together, so that the first substrate 51, the second substrate 52 and the jointing element 55 form a receptacle S, in which the display medium 56 is disposed. The jointing element 55 of the fifth embodiment is an adhesive agent (sealant), which may be, for example but without limitation to, the thermosetting sealant or UV-curing sealant.

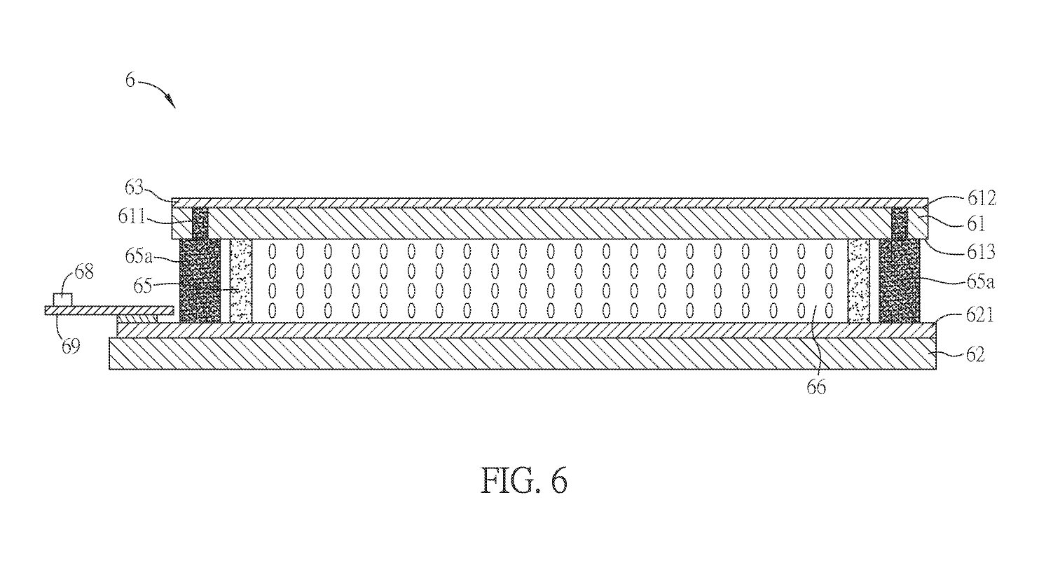

FIG. 6 is a cross-sectional view showing a touch display panel according to a sixth embodiment of the invention. As shown in FIG. 6, most of the structure of the touch display panel 6 of the sixth embodiment may be obtained from the fourth embodiment. In addition to the jointing element 65, the touch display panel 6 further includes a conducting jointing element 65a disposed between the first substrate 61 and the second substrate 62, wherein at least a portion of the first through hole 611 is disposed in the contact region between the first substrate 61 and the conducting jointing element 65a so that the conducting jointing element 65a can be electrically connected to the first through hole 611. Thus, the jointing element 65 of the sixth embodiment is the same as that of the fifth embodiment, and is an adhesive agent (sealant), which may be, for example but without limitation to, the thermosetting sealant or UV-curing sealant, but does not have the conducting material. In addition, the conducting jointing element 65a may be disposed outside or inside the jointing element 65, and is preferably disposed outside the jointing element 65, so that the first through hole 611 is disposed at the position close to the outer edge of the first substrate 61, and the touch electrode unit 63 may be provided with the electrodes over the larger range. Because the touch control integrated circuit 68 is electrically connected to the traces on the second substrate 62, the touch electrode unit 63 can be electrically connected to the second substrate 62 through the conducting first through hole 611 and the conducting jointing element 65a, and thus be electrically connected to the touch control integrated circuit 68.

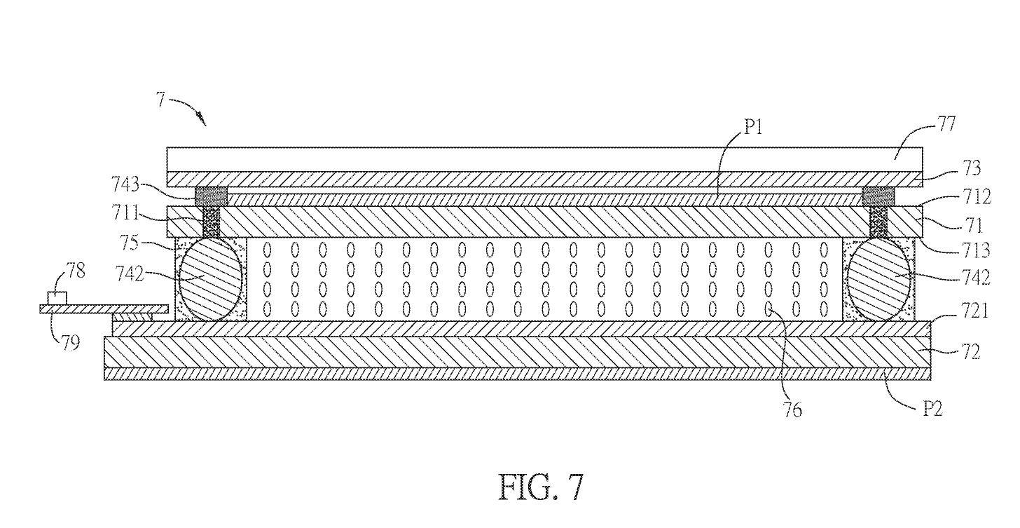

FIG. 7 is a cross-sectional view showing a touch display panel according to a seventh embodiment of the invention. As shown in the example of the seventh embodiment of FIG. 7, the touch electrode unit 73 is disposed on an externally added protection substrate 77, and this aspect may also be referred to as the On Glass Solution (OGS). The protection substrate 77 is a light-permeable substrate made of the glass or plastic material. Similarly, most of the structure of the touch display panel 7 of the seventh embodiment may be obtained from the fourth embodiment. In addition, the touch display panel 7 further includes a third conducting material 743, which is disposed between the touch electrode unit 73 and the first substrate 71. Preferably, the third conducting materials 743 are separately disposed on the second surface 713 of the first substrate 71 or four lateral sides on the surface of the touch electrode unit 73 corresponding to the first substrate 71 by way of dispensing to electrically connect the touch electrode unit 73 to the conducting first through hole 711. The separate arrangement may be determined according to the electrodes or metal wires (see the fourth embodiment) on the touch electrode unit 73. With the arrangements of the third conducting material 743 and the first through hole 711, the touch electrode unit 73 may be electrically connected to the second surface 713 of the first substrate 71. In other words, in the seventh embodiment, the first substrate 71, the second substrate 72, the jointing element 75 and the display medium 76 may be regarded as a display panel without a touch control layer, that is, a display panel without the touch function. The touch electrode unit 73 and the protection substrate 77 are disposed on one side of the display panel without the touch function in an externally added manner. In addition, an upper polarizer P1 may further be disposed in the space between the touch electrode unit 73 and the first substrate 71, which is the space formed after the third conducting material 743 is provided, and a lower polarizer P2 is disposed on the lower surface of the second substrate 72. However, the invention is not particularly restricted thereto. In addition, the protection substrate 77 is adhered to the first substrate 71, and the touch electrode unit 73 is disposed on the protection substrate 77 and between the protection substrate 77 and the first substrate 71.

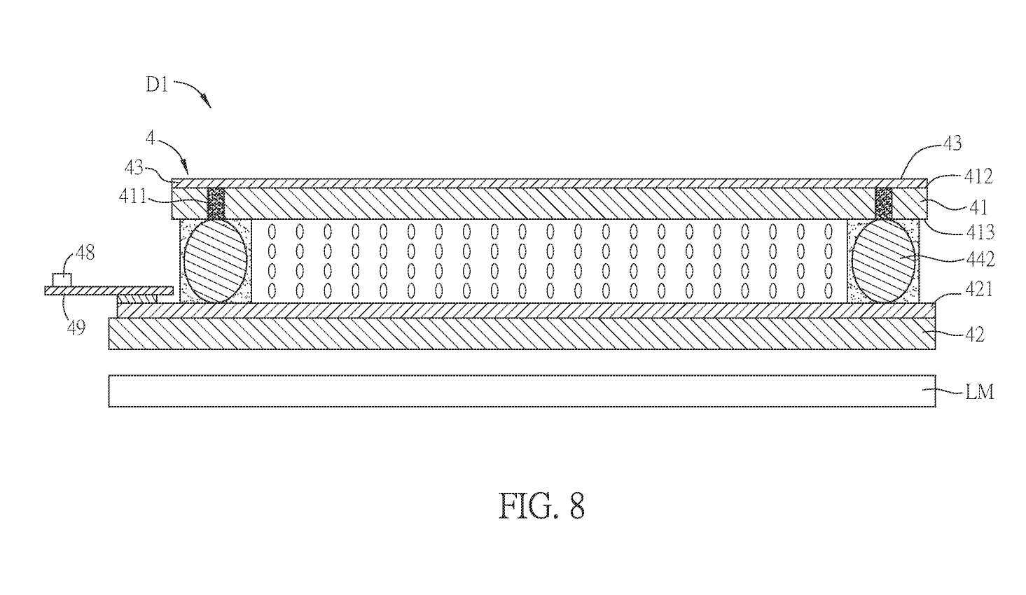

FIG. 8 is a cross-sectional view showing a touch display apparatus according to one embodiment of the invention. Referring to FIG. 8, the invention further discloses a touch display apparatus D1, which includes a backlight source module LM and the touch display panel 4a, so that the touch display panel 4a (5 to 7, wherein only the touch display panel 4a is described as an example) of each embodiment and the backlight source module LM are combined to form the touch display apparatus D1. In this embodiment, the backlight source module LM may be, for example but without limitation to, a cold cathode fluorescent lamp (CCFL), a hot cathode fluorescent lamp (HCFL) or a light emitting diode (LED).

In addition, the descriptions of the touch display panel 4a may be referred to the above-mentioned embodiments, and detailed descriptions thereof will be omitted. In this embodiment, the backlight source module LM is disposed on one side close to the second substrate 42 (disposed closed to one side of the first substrate 51 in the fifth embodiment).

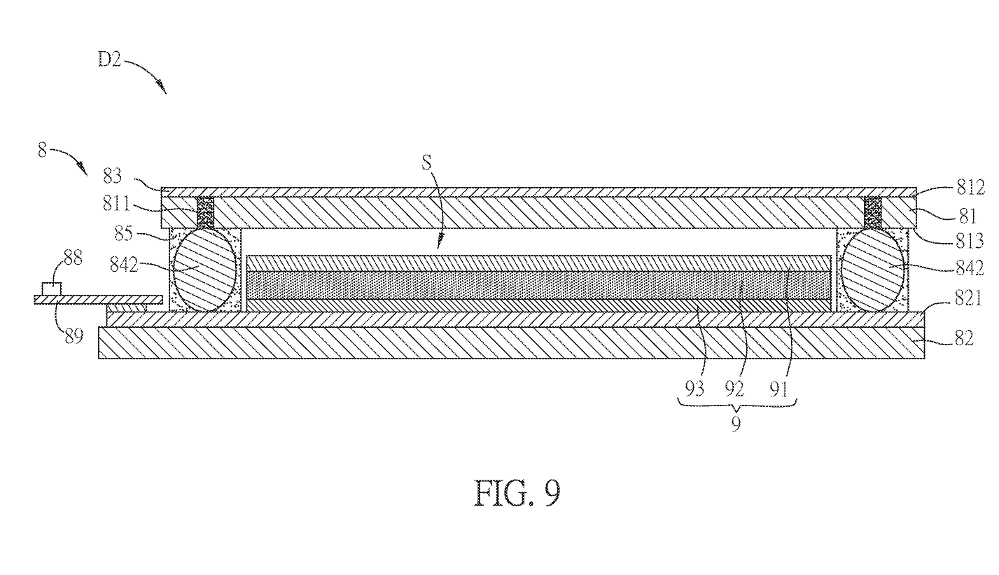

FIG. 9 is a cross-sectional view showing a touch display apparatus according to another embodiment of the invention. As shown in FIG. 9, the touch display apparatus D2 is an OLED display apparatus serving as an example, wherein the light source module of the OLED display apparatus is an OLED element module. The touch display apparatus D2 includes a touch display panel 8 and a light source module (OLED layer 9), and the first substrate 81 may be the glass, plastic or any other light-permeable substrate serving as the substrate for package, and have a plurality of first through holes 811. The second substrate 82 is a light-permeable or opaque substrate and has a thin-film transistor (TFT) matrix circuit.

In addition, the OLED layer 9 serving as the light source module is disposed in the receptacle S formed by the first substrate 81, the second substrate 82 and the jointing element 85. In other words, the first substrate 81 is disposed on one side of the light source module (OLED layer 9). The OLED layer 9 includes an anode layer 91, an organic material layer 92 (including an emitting layer and a conducting layer) and a cathode layer 93. In order to simplify the description, only one OLED layer 9 is illustrated as an example without differentiating between different pixels or sub-pixels. Of course, the receptacle S may have a plurality of regions of OLED layers 9. Similarly, the provision of the first through hole 811 and the jointing element 85 enables the touch electrode unit 83 to be electrically connected to the conductive pattern layer 821 of the second substrate 82. The elements associated with the touch display panel and the connection relationships therebetween can be obtained hereinabove, and detailed descriptions thereof will be omitted.

In summary, the touch display panel and the touch display apparatus of the invention electrically connect the touch electrode units to the conductive pattern layer through the conducting units, so that the touch panel and the display panel share the integrated circuit. In some embodiments, the touch electrode unit may be electrically connected to the conductive pattern layer to share the integrated circuit through the conducting unit, so that the use of the integrated circuit can be decreased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A touch display panel, comprising:
a first substrate;
a second substrate, which is disposed opposite to the first substrate and has a conductive pattern layer;
a touch electrode unit disposed on one side of the first substrate which is away from the second substrate; and
at least one conducting unit having one end connected to the touch electrode unit, and the other end connected to the conductive pattern layer of the second substrate.

2. The touch display panel according to claim 1, further comprising:
a support formed on an interface between a surface of the second substrate and a side surface of the first substrate, wherein the conducting unit is formed on the support.

3. The touch display panel according to claim 1, wherein the conducting unit comprises a flexible printed circuit.

4. The touch display panel according to claim 1, wherein the touch display panel comprises a plurality of conducting units, and the touch electrode unit comprises a plurality of first direction electrodes and a plurality of second direction electrodes, wherein the first direction electrodes and the second direction electrodes are electrically connected to the conductive pattern layer on different lateral sides of the second substrate through the conducting units, respectively.

5. The touch display panel according to claim 1, wherein the first substrate has a plurality of first through holes, a first surface and a second surface opposite to the first surface, wherein the first through holes penetrate through the first surface and the second surface, and the touch electrode unit and the first surface of the first substrate are disposed on the same side.

6. The touch display panel according to claim 5, further comprising:
a jointing element, which is disposed between the first substrate and the second substrate, and has at least one second through hole, wherein at least a portion of the second through hole is disposed correspondingly to one of the first through holes.

7. The touch display panel according to claim 6, wherein the conducting unit comprises:
a first conducting material disposed on an inside or a hole wall of the first through hole; and
a second conducting material disposed in the second through hole, wherein the touch electrode unit is electrically connected to the conductive pattern layer of the second substrate through the first conducting material of the first through hole and the second conducting material of the second through hole.

8. The touch display panel according to claim 6, wherein at least a portion of the first through holes is disposed in a contact region between the first substrate and the jointing element.

9. The touch display panel according to claim 5, wherein the conducting unit comprises:
a conducting jointing element, which is disposed between the first substrate and the second substrate, and electrically connected to the first through holes.

10. The touch display panel according to claim 9, wherein at least a portion of the first through holes is disposed in a contact region between the first substrate and the conducting jointing element.

11. The touch display panel according to claim 1, further comprising:
a touch control integrated circuit, which is disposed on the second substrate and electrically connected to the conducting unit through the conductive pattern layer of the second substrate.

12. The touch display panel according to claim 1, further comprising:
a touch control integrated circuit; and
an electrical connection member, wherein the conductive pattern layer of the second substrate is electrically connected to the touch control integrated circuit through the electrical connection member.

13. The touch display panel according to claim 1, comprising a liquid crystal display panel, a light emitting diode (LED) display panel or an organic light emitting diode (OLED) display panel.

14. A touch display panel, comprising:
a first substrate having a plurality of first through holes, a conductive pattern layer, a first surface and a second surface opposite to the first surface, wherein the first through holes penetrate through the first surface and the second surface, and the conductive pattern layer is disposed on the second surface of the first substrate;
a second substrate disposed opposite to the first substrate; and
a touch electrode unit disposed on the same side as the first surface of the first substrate, wherein the touch electrode unit is electrically connected to one side of the second surface of the first substrate through the first through holes;
wherein the conductive pattern layer is electrically connected to the touch electrode unit through the first through holes.

15. The touch display panel according to claim 14, wherein the touch display panel comprises a plurality of conducting units, and the touch electrode unit comprises a plurality of first direction electrodes and a plurality of second direction electrodes, wherein the first direction electrodes and the second direction electrodes are electrically connected to the conductive pattern layer on different lateral sides of the second substrate through the conducting units, respectively.

16. A touch display apparatus, comprising:
a backlight source module; and
a touch display panel, comprising:
a first substrate;
a second substrate, which is disposed opposite to the first substrate and has a conductive pattern layer;
a touch electrode unit disposed on one side of the first substrate which is away from the second substrate; and
at least one conducting unit having one end connected to the touch electrode unit, and the other end connected to the conductive pattern layer of the second substrate;
wherein the backlight source module is disposed on one side of the second substrate.

17. The touch display apparatus according to claim 16, further comprising:
a support formed on an interface between a surface of the second substrate and a side surface of the first substrate, wherein the conducting unit is formed on the support.

18. The touch display apparatus according to claim 16, wherein the conducting unit comprises a flexible printed circuit.

19. The touch display apparatus according to claim 16, wherein the touch display panel comprises a plurality of conducting units, and the touch electrode unit comprises a plurality of first direction electrodes and a plurality of second direction electrodes, wherein the first direction electrodes and the second direction electrodes are electrically connected to the conductive pattern layer on different lateral sides of the second substrate through the conducting units, respectively.

20. The touch display apparatus according to claim 16, further comprising:
a touch control integrated circuit, which is disposed on the second substrate and electrically connected to the conducting unit through the conductive pattern layer of the second substrate.

21. The touch display apparatus according to claim 16, further comprising:
a touch control integrated circuit; and
an electrical connection member, wherein the conductive pattern layer of the second substrate is electrically connected to the touch control integrated circuit through the electrical connection member.

22. The touch display apparatus according to claim 16, comprising a liquid crystal display panel.
